(19) United States
(12) Patent Application Publication
(10) Pub. No.: US 2025/0317989 A1
(43) Pub. Date: Oct. 9, 2025

(54) METHOD AND APPARATUS FOR RANDOM ACCESS IN A WIRELESS COMMUNICATION SYSTEM

(71) Applicant: Samsung Electronics Co., Ltd., Suwon-si (KR)

(72) Inventors: Cuiwei TANG, Beijing (CN); Di SU, Beijing (CN); Chen QIAN, Beijing (CN); Qi LI, Beijing (CN); Hang QI, Beijing (CN)

(21) Appl. No.: 19/169,409

(22) Filed: Apr. 3, 2025

(30) Foreign Application Priority Data
Apr. 3, 2024 (CN) 202410404559.4
Apr. 19, 2024 (CN) 202410480841.0

(51) Int. Cl. H04W 74/0833

(52) U.S. Cl. CPC H04W 74/0833

(57) ABSTRACT

The disclosure relates to a fifth generation (5G) communication system or a sixth generation (6G) communication system for supporting higher data rates beyond a fourth generation (4G) communication system, such as long term evolution (LTE). A method performed by a first device in a communication system is provided. The method includes performing random access procedure, wherein information associated with a first device type is transmitted to a base station during the random access procedure, and transmitting and/or receiving signals based on first resource among scheduled first type resources dedicated to a first device type, wherein the first device type is associated with fixed wireless access technology.

### CROSS-REFERENCE TO RELATED APPLICATION(S)

This application is based on and claims priority under 35 U.S.C. § 119(a) of a Chinese patent application number 202410404559.4, filed on Apr. 3, 2024, in the Chinese National Intellectual Property Administration, and of a Chinese patent application number 202410480841.0, filed on Apr. 19, 2024, in the Chinese National Intellectual Property Administration, the disclosure of each of which is incorporated by reference herein in its entirety.

### BACKGROUND

### 1. Field

The disclosure relates to the field of communication. More particularly, the disclosure relates to a method and an apparatus for random access in a wireless communication system.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 psec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies, such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems, a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. More particularly, it is expected that services, such as truly immersive extended reality (XR), high-fidelity mobile hologram, and digital replica could be provided through 6G communication systems. In addition, services, such as remote surgery for security and reliability enhancement, industrial automation, and emergency response will be provided through the 6G communication system such that the technologies could be applied in various fields, such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for random access in a wireless communication system.

Additional aspects will be set forth in part in the description which follows and, in part, will be apparent from the description, or may be learned by practice of the presented embodiments.

In accordance with an aspect of the disclosure, a method performed by a first device in a communication system is provided. The method includes performing random access procedure, wherein information associated with a first device type is transmitted to a base station in the random access procedure, and transmitting and/or receiving signals based on first resource among scheduled first type resources dedicated to the first device type, wherein the first device type is associated with fixed wireless access technology.

In an implementation, the method further includes receiving first information related to resource location of RO dedicated to the first device type on the first type resources, wherein, the performing random access procedure includes transmitting preamble on the RO dedicated to the first device type.

In an implementation, the first information includes an offset between the resource location of the RO dedicated to the first device type and the resource of the RO not dedicated to the first device type or the first type resources.

In an implementation, the offset is a time domain offset and/or a frequency domain offset.

In an implementation, the first information is received through system information or high layer signaling.

In an implementation, the method further includes receiving second information related to RO dedicated to the first device type among ROs on second type resources and/or third information related to preamble dedicated to the first device type among random access preambles, wherein the location of the second type resources is different from that of the first type resources, wherein, the performing random access procedure includes performing random access procedure on the RO dedicated to the first device type and/or using the preamble dedicated to the first device type.

In an implementation, the second information includes at least one index of ROs dedicated to the first device type among ROs on the second type resources, and the third information includes at least one index of preambles dedicated to the first device type among random access preambles.

In an implementation, the second information and/or the third information are received through a downlink channel indicated by a broadcast channel in SSB.

In an implementation, the information associated with the first device type is transmitted to the base station in the random access procedure, includes reporting the information associated with the first device type to the base station by the first device through message 3 during random access procedure.

In an implementation, the performing random access procedure includes monitoring random access response (RAR) from the base station on common control channel on the first type resources, wherein, the location of the common control channel on the first type resources is determined by resource location related information or information on offset relative to location of common control channel on the second type resources in the system information.

In an implementation, the performing random access procedure includes monitoring the RAR from the base station on common control channel of the second type resources, wherein the RAR includes location information of the first type resources, or the location information is transmitted to the first device through system information or high layer signaling.

In an implementation, the performing random access procedure includes receiving a contention resolution message on the first type resources.

In an implementation, the receiving a contention resolution message on the first type resources includes receiving the contention resolution message by monitoring a common control channel on the first type resources, or obtaining location of the contention resolution message on the first type resources by monitoring the common control channel on the second type resources, and obtaining the contention resolution message at the location.

In an implementation, the performing random access procedure includes receiving a contention resolution message on the second type resources, wherein the contention resolution message includes information on location of scheduled first resources for the terminal.

In an implementation, the performing random access procedure includes receiving a contention resolution message, wherein the contention resolution message includes first information for indicating whether the contention resolution message includes a contention resolution scheme or RO resource configuration information.

In an implementation, if the first information indicates that the contention resolution message includes a contention resolution scheme, the contention resolution message also includes terminal identification information.

In an implementation, if the first information indicates that the contention resolution message includes RO resource configuration information, the first device re-performs random accesses using RO resource obtained based on the RO resource configuration information.

In an implementation, the RO resource is on the first type resources.

In an implementation, if the random access re-performed by the first device using the RO resource fails, the first device re-performs random access on the RO resource based on the valid time of the RO resource, or the first device re-performs random access at RO on the second type resources, wherein the valid time is obtained based on the RO resource configuration information.

In an implementation, the valid time includes one of absolute time length, the number of valid slots, and the number of valid ROs.

In an implementation, the performing random access procedure includes transmitting a random access request to the base station based on second information obtained through the last random access procedure.

In an implementation, the second information includes timing advance, SSB index.

In an implementation, the transmitting a random access request to the base station based on the second information includes transmitting the random access request using reserved resources determined based on the SSB and the timing advance.

In an implementation, the method further includes measuring reference signal receiving power reference signal received power (RSRP) of corresponding SSB according to the SSB index, if the RSRP is not less than a threshold, transmitting the random access request to the base station based on the second information.

In an implementation, the performing random access procedure further includes detecting downlink control information on common control channel, wherein the downlink control information includes device identification information or RO resource configuration information.

In an implementation, if the downlink control information includes RO resource configuration information, the first device transmits a preamble on RO resource obtained based on the RO resource configuration information to re-perform random access.

In accordance with another aspect of the disclosure, a method performed by a base station in a communication system is provided. The method includes allocating first type resources, obtaining information associated with a first device type through a random access procedure with a first device, and scheduling first resource among the first type resources to the first device.

In accordance with another aspect of the disclosure, a first device in a communication system is provided. The first device includes a transceiver configured to transmit and/or receive signals, and a controller configured to control the first device to perform random access procedure, wherein information associated with a first device type is transmitted to a base station during the random access procedure, and transmit and/or receive signals based on a first resource among scheduled first type resources dedicated to the first device type, wherein the first device type is associated with fixed wireless access technology.

In accordance with another aspect of the disclosure, a base station in a communication system is provided. The base station includes a transceiver configured to transmit and/or receive signals, and a controller configured to control the base station to perform the method according to at least one embodiment of the disclosure.

In accordance with another aspect of the disclosure, a method performed by a first device in a communication system is provided. The method includes receiving at least one signal/physical broadcast channel block (SSB), determining a first SSB from the at least one SSB based on historical SSB included in historical information, wherein the historical SSB includes the first SSB, determining a transmission power based on second information associated with the first SSB included in the historical information, and transmitting a preamble based on the transmission power, wherein, the second information includes at least one of a power ramping counter value and a power ramping step size.

In an implementation, the historical information includes at least one of cell identification (ID) and SSB index.

In an implementation, the historical SSB includes at least one of SSB on which the last random access is based, SSBs on which the latest M times random accesses are based, where M is a positive integer, and SSB before corresponding relationship between SSB and beam will change.

In an implementation, the method further includes receiving configuration information, wherein the configuration information includes a first power ramping step size and a second power ramping step size, wherein, the determining of a transmission power based on second information includes determining the transmission power based on the power ramping counter value and power ramping step size in the second information, and the first power ramping step size and the second power ramping step size.

In an implementation, the determining the transmission power based on the power ramping counter value and power ramping step size in the second information, and the first power ramping step size and the second power ramping step size, includes determining a first transmission power based on the first power ramping step size, and determining a second transmission power based on the second power ramping step size if the first transmission power is greater than the historical transmission power determined based on the power ramping counter value and the power ramping step size in the second information.

In an implementation, the second power ramping step is smaller than the first power ramping step.

In an implementation, determining a transmission power of a random access channel based on the second information includes determining the transmission power based on a product of a power ramping counter value of included in the second information −1 and a power ramping step size included in the second information.

In an implementation, determining a transmission power of the random access channel based on the second information includes initializing the power ramping counter based on the power ramping counter value included in the second information, determining the transmission power based on the initialized power ramping counter.

In an implementation, initializing the power ramping counter based on the power ramping counter value included in the second information includes initializing the power ramping counter to one of at least two values based on a result of comparing path loss to a first threshold, wherein the at least two values are based on the power ramping counter value included in the second information.

In an implementation, the first threshold is related to a reference value of path loss.

In an implementation, the reference value includes at least one of a measured value of path loss under a specified condition and a value obtained based on at least one measured value of path loss.

In an implementation, the method further includes determining whether the corresponding relationship between SSB and beam will change, if it is determined that the corresponding relationship between SSB and beam will not change, determining the historical information is available, and if it is determined that the corresponding relationship between SSB and beam will change, determining the historical information is not available.

In an implementation, determining whether the corresponding relationship between SSB and beam will change includes at least one of determining whether the corresponding relationship between SSB and beam will change through third information in received SSB indicating whether the corresponding relationship between SSB and beam will change or indicating a time point when the corresponding relationship between SSB and beam will change, determining whether the corresponding relationship between SSB and beam will change based on path loss and a second threshold, and determining whether the corresponding relationship between SSB and beam will change based on path loss associated with the first SSB included in the historical information and a third threshold.

In accordance with another aspect of the disclosure, a method performed by a first device in a communication system is provided. The method includes receiving at least one signal/physical broadcast channel block (SSB), determining a first SSB from the at least one SSB based on historical SSB included in historical information, wherein the historical SSB includes the first SSB, determining a beam used for transmission or a beam used for reception or a random access channel occasion based on second information associated with the first SSB included in the historical information, the second information also includes at least one of information related to the beam used for transmission, information related to the beam used for reception, information related to the random access channel occasion, and the number of random accesses.

In an implementation, the information related to the beam used for transmission includes information related to codebook index of the beam used for transmission, the codebook index includes the codebook index of the beam used when the first device performs random access based on the first SSB in the second information, or the codebook index related to the codebook index, and/or information related to the resources used for the transmission of random access channel includes information related to the resource location of the random access occasion RO.

In an implementation, the method further includes the first device receiving the first SSB using a codebook index based on the receive beam associated with the first SSB in the historical information.

In an implementation, the receive beam is a beam determined based on initial access or a beam determined based on beam management.

In an implementation, determining a first SSB for random access based on historical information related to random access of a first device includes determining whether SSBs received in a first time period include the first SSB included in the historical information, and if the SSBs received in the first time period do not include the first SSB, receiving SSBs in a second time period after the first time period and performing random access based on the N-^{th} received SSB, wherein the length of the second time period is not greater than the first time period, and N is a positive integer.

In an implementation, the historical information is stored using a first list including SSB index and second information.

In an implementation, the method further includes determining whether corresponding relationship between SSB and beam will change, if it is determined that the corresponding relationship between SSB and beam will not change, determining the historical information is available, if it is determined that the corresponding relationship between SSB and beam will change, determining the historical information is not available.

In an implementation, determining whether the corresponding relationship between SSB and beam will change includes at least one of determining whether the corresponding relationship between SSB and beam will change through third information in the received SSB indicating whether the corresponding relationship between SSB and beam will change or indicating a time point when the corresponding relationship between SSB and beam will change, determining whether the corresponding relationship between SSB and beam will change based on path loss and a second threshold, and determining whether the corresponding relationship between SSB and beam will change based on path loss associated with the first SSB included in the historical information and a third threshold.

In accordance with another aspect of the disclosure, a method performed by a base station in a communication system is provided. The method includes transmitting a plurality of signal/physical broadcast channel blocks (SSBs) including a first SSB, and receiving a preamble sent by a first device, wherein a transmission power of the preamble is transmitted based on a first SSB among historical SSB in historical information, wherein a transmission power of random access channel is determined based on second information associated with the first SSB included in the historical information, and wherein, the second information includes at least one of a power ramping counter value and a power ramping step size.

In accordance with another aspect of the disclosure, a method performed by a base station in a communication system is provided. The method includes transmitting a plurality of signal/physical broadcast channel blocks (SSBs) including a first SSB, and receiving a preamble sent by a first device, wherein the preamble is transmitted based on the first SSB, wherein the first SSB is included in historical SSB, and the historical SSB is included in historical information, wherein the beam or random access channel occasion used for transmission of the preamble is determined based on the second information associated with the first SSB included in the historical information, and wherein the second information also includes at least one of information related to a beam used for transmission, information related to a beam used for reception, information related to the random access channel occasion, and the number of random accesses.

In accordance with another aspect of the disclosure, a user equipment first device in a communication system is provided. The user equipment first device includes a transceiver configured to transmit and/or receive signals and a controller configured to control the first device to perform the method according to the embodiment of the disclosure.

In accordance with another aspect of the disclosure, a base station in a communication system is provided. The base station includes a transceiver configured to transmit and/or receive signals and a controller configured to control the base station to execute the method according to the embodiment of the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIG. 2 illustrates a base station according to an embodiment of the disclosure;

FIG. 3 illustrates a user equipment according to an embodiment of the disclosure;

FIG. 4 illustrates a schematic block diagram of a device for performing fixed wireless access (FWA) according to an embodiment of the disclosure;

FIG. 5 illustrates a schematic diagram in which resources are divided into FWA-dedicated resources and non-FWA-dedicated resources according to an embodiment of the disclosure;

FIG. 6 illustrates a schematic diagram of an initial random access procedure according to an embodiment of the disclosure;

FIG. 7 illustrates a schematic diagram in which non-CPE-dedicated RO resources are located on non-dedicated resources and CPE-dedicated RO resources are located on dedicated resources according to an embodiment of the disclosure;

FIG. 8 illustrates a schematic diagram of allocating dedicated RO and/or preamble to a CPE-type terminal on non-dedicated resources according to an embodiment of the disclosure;

FIG. 9 illustrates a schematic diagram of a CPE type terminal transmitting CPE type indication when transmitting a message 3(msg3) according to an embodiment of the disclosure;

FIG. 10 illustrates a structure of a contention resolution message according to an embodiment of the disclosure;

FIG. 11 illustrates a terminal behavior according to an embodiment of the disclosure;

FIG. 12 illustrates a schematic diagram of beams of a base station and a terminal according to an embodiment of the disclosure;

FIG. 13 illustrates a schematic diagram of beams used by the base station and CPE for SSB transmission and reception according to an embodiment of the disclosure;

FIG. 14 illustrates a schematic diagram of a method according to an embodiment of the disclosure;

FIG. 15 illustrates a schematic diagram of receiving SSB by CPE using previously used beam according to an embodiment of the disclosure;

FIG. 16 illustrates a schematic diagram of receiving SSB by CPE using a beam related to previously used beam according to an embodiment of the disclosure;

FIGS. 17 and 18 illustrate schematic diagrams of CPE storing SSB-related data according to various embodiments of the disclosure;

FIGS. 19 and 20 illustrate schematic diagrams of methods according to various embodiments of the disclosure;

FIGS. 21 and 22 illustrate schematic diagrams of CPE storing SSB-related data according to various embodiments of the disclosure;

FIG. 23 illustrates a schematic diagram of receiving SSB by CPE using previously used beam according to an embodiment of the disclosure;

FIG. 24 illustrates a schematic diagram of receiving SSB by CPE using a beam related to previously used beam according to an embodiment of the disclosure;

FIG. 25 illustrates a schematic diagram of a method according to an embodiment of the disclosure;

FIG. 26 illustrates a schematic structural diagram of a first device according to an embodiment of the disclosure; and

FIG. 27 illustrates a structural schematic diagram of a base station or a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The figures included herein, and the various embodiments used to describe the principles of the disclosure are by way of illustration only and should not be construed in any way to limit the scope of the disclosure. Further, those skilled in the art will understand that the principles of the disclosure may be implemented in any suitably arranged wireless communication system.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

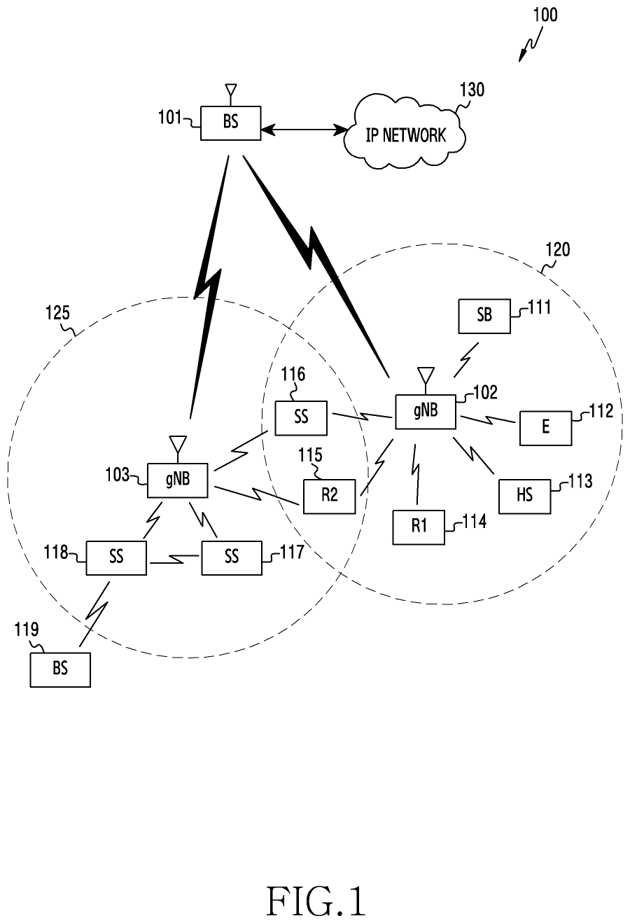

FIGS. 1-27 below describe various embodiments of the disclosure implemented in wireless communications systems. The descriptions of FIGS. 1-27 are not meant to imply physical or architectural limitations to the manner in which different embodiments may be implemented. Different embodiments of the disclosure may be implemented in any suitably-arranged communications system.

FIG. 1 illustrates a wireless network according to an embodiment of the disclosure. The embodiment of the wireless network shown in FIG. 1 is for illustration only. Other embodiments of the wireless network 100 could be used without departing from the scope of the disclosure.

Referring to FIG. 1, the wireless network 100 includes a base station (next generation nodeB, gNB or gNodeB) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E), a UE 113, which may be located in a WiFi hotspot (HS); a UE 114, which may be located in a first residence (R1); a UE 115, which may be located in a second residence (R2); and a UE 116, which may be a mobile device (M), such as a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116, as well as subscriber stations (SS, for example, UEs) 117, 118 and 119. In some embodiments of the disclosure, one or more of the gNBs 101-103 may communicate with each other and with the UEs 111-116 using existing wireless communication techniques, and one or more of the UE 111-119 may communicate directly with each other (e.g., UEs 117-119) using other existing or proposed wireless communication techniques.

Depending on the network type, the term “base station” or “BS” can refer to any component (or collection of components) configured to provide wireless access to a network, such as transmit point (TP), transmit-receive point (TRP), an enhanced (or “evolved”) base station (eNodeB or eNB), a 5G base station (gNB), a macrocell, a femtocell, a wireless fidelity (WiFi) access point (AP), or other wirelessly enabled devices. Base stations may provide wireless access in accordance with one or more wireless communication protocols, e.g., 3GPP 5G New Radio (NR), Long Term Evolution (LTE), LTE Advanced (LTE-A), high speed packet access (HSPA), Wi-Fi 802.11a/b/g/n/ac, or the like. For the sake of convenience, the various names for a base station-type apparatus and functionality are used interchangeably in this patent document to refer to network infrastructure components that provide wireless access to remote terminals. In addition, depending on the network type, the term “user equipment” (UE) can refer to any component, such as a mobile station (MS), subscriber station (SS), remote terminal, wireless terminal, receive point, or user device. For the sake of convenience, the various names for a user equipment-type device and functionality are used interchangeably in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described below, one or more of the UEs 111-119 include circuitry, programing, or a combination thereof. In certain embodiments of the disclosure, and one or more of the gNBs 101-103 includes circuitry, programing, or a combination thereof.

Although FIG. 1 illustrates one example of a wireless network, various changes may be made to FIG. 1. For example, the wireless network could include any number of gNBs and any number of UEs in any suitable arrangement. In addition, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

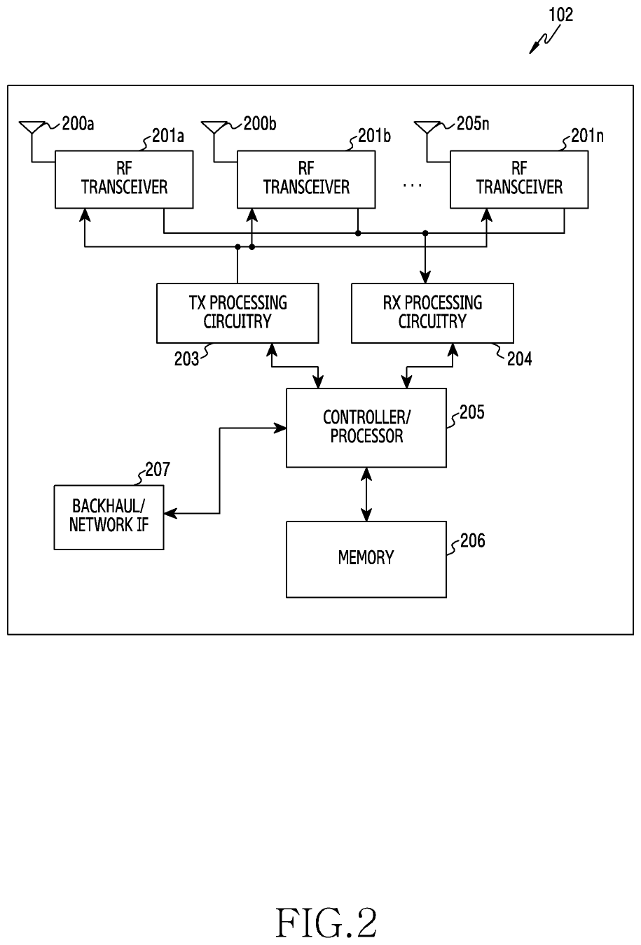

FIG. 2 illustrates a base station according to an embodiment of the disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the disclosure to any particular implementation of a gNB.

Referring to FIG. 2, the gNB 102 includes multiple antennas 200a-200n, multiple radio frequency (RF) transceivers 201a-201n, transmit (TX) processing circuitry 203, and receive (RX) processing circuitry 204. The gNB 102 also includes a controller/processor 205, memory 206, and a backhaul or network interface 207.

The RF transceivers 201a-201n receive, from the antennas 200a-200n, incoming RF signals, such as signals transmitted by UEs in the network 100. The RF transceivers 201a-201n down-convert the incoming RF signals to generate intermediate frequency (IF) or baseband signals. The IF or baseband signals are transmitted to the RX processing circuitry 204, which generates processed baseband signals by filtering, decoding, and/or digitizing the baseband or IF signals. The RX processing circuitry 204 transmits the processed baseband signals to the controller/processor 205 for further processing.

The TX processing circuitry 203 receives analog or digital data (such as voice data, web data, electronic mail, or interactive video game data) from the controller/processor 205. The TX processing circuitry 203 encodes, multiplexes, and/or digitizes the outgoing baseband data to generate processed baseband or IF signals. The RF transceivers 201a-201n receive the outgoing processed baseband or IF signals from the TX processing circuitry 203 and up-converts the baseband or IF signals to RF signals that are transmitted via the antennas 201a-201n.

The controller/processor 205 can include one or more processors or other processing devices that control the overall operation of the gNB 102. For example, the controller/processor 205 could control the reception of forward channel signals and the transmission of reverse channel signals by the RF transceivers 201a-201n, the RX processing circuitry 204, and the TX processing circuitry 203 in accordance with well-known principles. The controller/processor 205 could support additional functions as well, such as more advanced wireless communication functions.

For instance, the controller/processor 205 could support beam forming or directional routing operations in which outgoing signals from multiple antennas 200a-200n are weighted differently to effectively steer the outgoing signals in a desired direction. Any of a wide variety of other functions could be supported in the gNB 102 by the controller/processor 205.

The controller/processor 205 is also capable of executing programs and other processes resident in the memory 206, such as an operating system (OS). The controller/processor 205 can move data into or out of the memory 206 as required by an executing process.

The controller/processor 205 is also coupled to the backhaul or network interface 207. The backhaul or network interface 207 allows the gNB 102 to communicate with other devices or systems over a backhaul connection or over a network. The interface 207 could support communications over any suitable wired or wireless connection(s). For example, when the gNB 102 is implemented as part of a cellular communication system (such as one supporting 5G, LTE, or LTE-A), the interface 207 could allow the gNB 102 to communicate with other gNBs over a wired or wireless backhaul connection. When the gNB 102 is implemented as an access point, the interface 207 could allow the gNB 102 to communicate over a wired or wireless local area network or over a wired or wireless connection to a larger network (such as the Internet). The interface 207 includes any suitable structure supporting communications over a wired or wireless connection, such as an Ethernet or RF transceiver.

The memory 206 is coupled to the controller/processor 205. Part of the memory 206 could include random access memory (RAM), and another part of the memory 206 could include flash memory or other read only memory (ROM).

Although FIG. 2 illustrates one example of gNB 102, various changes may be made to FIG. 2. For example, the gNB 102 could include any number of each component shown in FIG. 2. As a particular example, an access point could include a number of interfaces 207, and the controller/processor 205 could support routing functions to route data between different network addresses. As another particular example, while shown as including a single instance of TX processing circuitry 203 and a single instance of RX processing circuitry 204, the gNB 102 could include multiple instances of each (such as one per RF transceiver). In addition, various components in FIG. 2 could be combined, further subdivided, or omitted and additional components could be added according to particular needs.

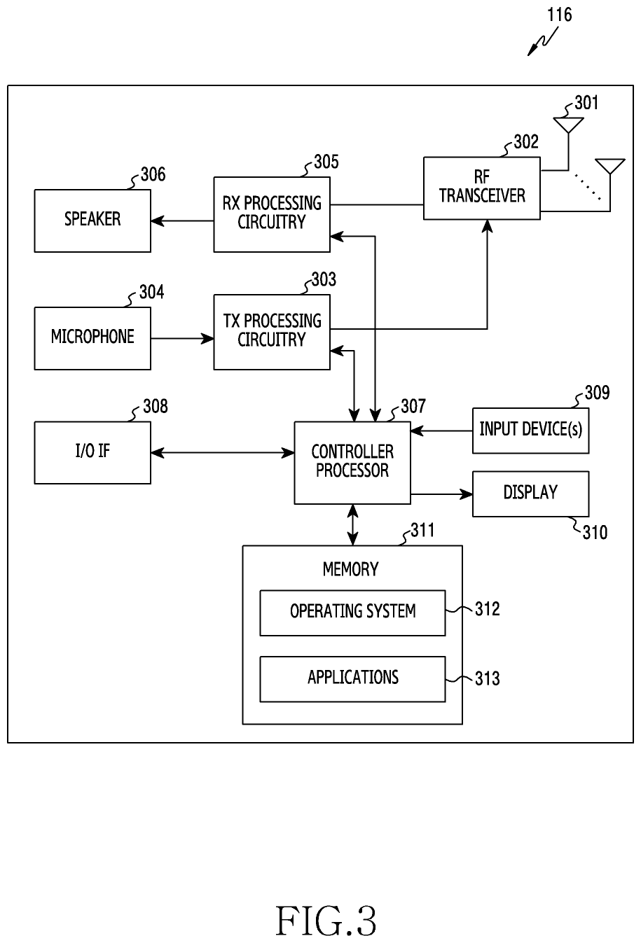

FIG. 3 illustrates a user equipment according to an embodiment of the disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the disclosure to any particular implementation of a UE.

Referring to FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, an input device 309, a touchscreen display 310, and memory 311. The memory 311 includes an OS 312 and one or more applications 313.

The RF transceiver 302 receives, from the antenna 301, an incoming RF signal transmitted by a gNB of the network 100. The RF transceiver 302 down-converts the incoming RF signal to generate an IF or baseband signal. The IF or baseband signal is transmitted to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments of the disclosure, the processor 307 includes at least one microprocessor or microcontroller.

The processor 307 is also capable of executing other processes and programs resident in the memory 311, such as processes for channel state information (CSI) reporting on uplink channel. The processor 307 can move data into or out of the memory 311 as required by an executing process. In some embodiments of the disclosure, the processor 307 is configured to execute the applications 313 based on the OS 312 or in response to signals received from gNBs or an operator. The processor 307 is also coupled to the I/O interface 308, which provides the UE 116 with the ability to connect to other devices, such as laptop computers and handheld computers. The I/O interface 308 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

With the rapid development of mobile communication technology, higher requirements are put forward for the transmission rate of the network. During the deployment and development of 5G/6G technology, the advantages of high-frequency communication are obvious, but it also exposes the problems of short transmission distance, high power consumption and high cost, especially in high-frequency bands, such as millimeter wave and terahertz (THz). To a certain extent, it limits the large-scale application. At present, only a few countries can provide services in the corresponding frequency band.

The transmission distance of a signal is inversely proportional to the operating frequency. For the same transmission power at base station and the same transmission distance, the higher the frequency of the transmitted signal, the greater the transmission path loss and the weaker the signal strength received by the terminal. In order to meet the complete coverage of high-frequency signals, the transmission power at base stations can be increased or the construction density of base stations can be increased, but the equipment cost and energy consumption at base stations will increase sharply, which will become a major obstacle to the large-scale commercialization of high-frequency communication.

FWA (fixed wireless access) is a technology that uses a CPE (customer premises equipment) device to realize broadband connection in a relatively fixed location through the infrastructure (wireless base station) of mobile operators. The fixed wireless access supporting 5G technology provides the potential of ultra-high speed, low delay and large capacity for the next generation wireless connection. In addition to home users, FWA can provide economical and convenient broadband access for small and micro enterprises, shops and temporary places, and gradually begin to enter the industrial Internet field in factories, parks, mines, ports and other scenes, providing high-speed and low-latency 5G connections for IoT terminals within a region.

In some areas where optical fiber and other wired cables cannot be laid (due to cost reasons, road rights reasons, building protection reasons, or the like), FWA can provide users with network access. It avoids the construction work, such as road right acquisition, pipeline excavation, cable laying and wall perforation, greatly simplifies the process of connecting network, shortens the construction period and saves the cost. Therefore, for many operators, FWA is a means to rapidly develop the scale of users, and it is also a very cost-effective business model. From the perspective of social significance, FWA can help families in economically underdeveloped areas to quickly have network connections, enjoy information dividends and improve their quality of life. In addition, in rural areas, the main market of FWA, there is usually extra spectrum capacity due to the low population density.

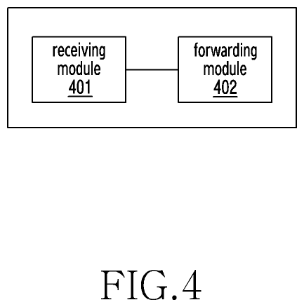

FIG. 4 illustrates a schematic block diagram of a device for performing fixed wireless access (FWA) according to an embodiment of the disclosure. Furthermore, the device for performing FWA is referred to a CPE equipment.

Referring to FIG. 4, the device related to FWA technology includes two parts: a receiving module 401 communicating with the base station and a forwarding module 402 communicating with other terminals. Furthermore, the receiving module 401 may be referred to a signal receiving module, and the forwarding module 402 maybe referred to a signal forwarding module. The receiving module 401 can communicate with the base station as a terminal, receive data from the base station, or transmit data to the base station, the signal forwarding module 402, which functions like a network hotspot, can provide services for one or more terminals in a designated area, transmit or sends data obtained from the receiving module 401 to different terminals, or receive information transmitted or sent by different terminals and forward it to the base station through the receiving module 401, the forwarding module 402 is connected with the receiving module 401, and transmits uplink data to the receiving module or receives downlink data obtained from the receiving module 401. The receiving module 401 and the forwarding module 402 may be two modules of a device related to FWA technology, or two functions of one module. The connection form between the base station and the receiving module 401 is wireless to provide connection in the last mile between the base station and the user, and the connection form between the forwarding module 402 and the terminal can be wired or wireless, such as network cable, WiFi, mobile network, optical fiber, or the like, so as to adapt to the connection requirements of different terminal types or the environment to which the terminal belongs.

The receiving module 401 for communication between CPE and the base station is usually installed in a fixed position, such as a wall, a hanging pole, a roof, or the like. Therefore, the relative position and transmission path between CPE and the base station change little, which can simplify the related processes (for example, cell search, random access, beam management) in the connection process with the base station, shorten the connection time, reduce the signaling overhead and improve the resource utilization rate. The inventor realized that the current communication process is highly complicated to meet the communication needs of mobile users, and it does not fully utilize the characteristics of relatively small changes in the position and transmission path between CPE and base stations in such scenario to simplify its related processes, such as random access procedure.

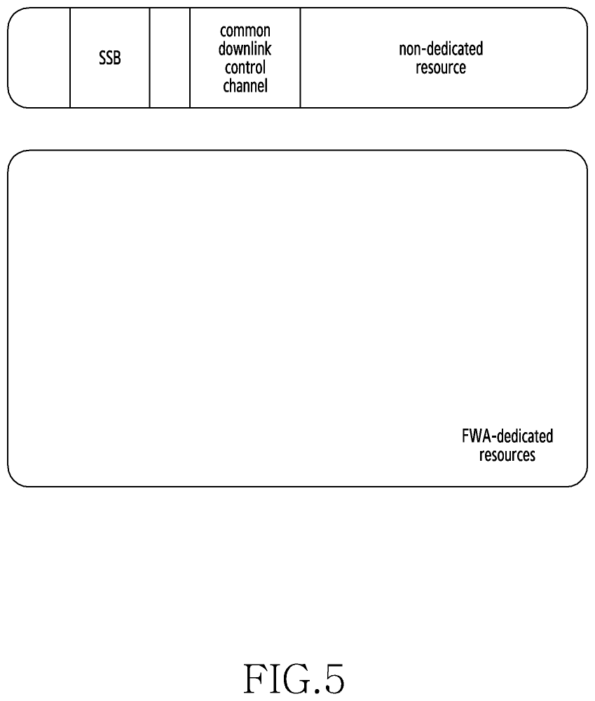

The disclosure provides methods for CPE to communicate with a base station, and the methods of the disclosed embodiments are described with reference to FIGS. 5 to 25. The disclosure involves a related process of communication between a signal receiving module of CPE and a base station.

In addition, it can be understood that the use of CPE or FWA herein is only as an example, not for limitation. The methods of the embodiments provided by the disclosure can also be applied to communication between a network device (e.g., a base station) and a user equipment (UE) or a terminal.

### Embodiment 1-1

In order to reduce the signaling overhead of FWA-type services and improve the throughput of FWA-type services, the base station can allocate FWA-dedicated resources (also referred to as “dedicated resources”, “first type resources” herein) to FWA-type services in a static or semi-static manner. In such a scheduling mode, the entire time-frequency resources are divided into FWA-dedicated resources and non-FWA-dedicated resources (also referred to as “non-dedicated resources” or “second type resources” herein), as shown in FIG. 5. Herein, FWA-dedicated resources and non-dedicated resources can be divided in frequency division or time division.

FIG. 5 illustrates a schematic diagram in which resources are divided into FWA-dedicated resources and non-FWA-dedicated resources according to an embodiment of the disclosure.

Referring to FIG. 5, Herein, common channels, such as synchronization signal/physical broadcast channel block (SSB), common control channel, or the like, are transmitted on non-FWA-dedicated resources. Other non-CPE terminals are scheduled on non-FWA-dedicated resources.

When terminals (including CPE and non-CPE terminals, in which CPE terminals are referred to as CPE for short in this disclosure) have data transmission requirements and need initial access, SSB search and measurement are first performed to complete downlink synchronization and system information reading and determine location of random access resources. Thereafter, CPE determines the RO for transmitting the random access preamble according to the association relationship between SSB and random access occasions (ROs), and transmits the preamble on the same.

The terminal monitors the random access response (RAR) on the downlink channel. Herein, the RAR carries timing advance, scheduling information for message 3 and temporary user identification information.

The terminal completes the timing adjustment according to the timing advance and the scheduling information for message 3 carried in the RAR, and transmits message 3 on the corresponding uplink time-frequency resources. Herein, the message 3 transmitted by the terminal carries user identification for establishing wireless connection.

The terminal monitors the downlink channel scheduled by the temporary user identification information on the downlink channel, and receives the contention resolution information therein to complete the initial access.

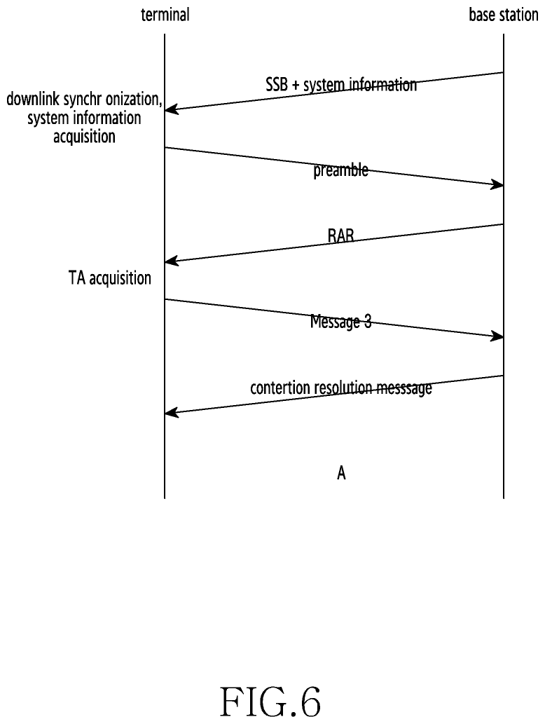

The schematic diagram of the above initial access process is shown in FIG. 6.

FIG. 6 illustrates a schematic diagram of an initial random access procedure according to an embodiment of the disclosure.

The aforementioned initial access procedure is performed on non-dedicated resources. For the terminal of CPE type, after completing the initial access procedure, the terminal type (CPE type) is reported to the base station through the uplink shared channel in the form of terminal capability. Alternatively, the CPE type can also be reported to the base station during random access procedure, for example, the CPE type can be reported to the base station in message 3. Alternatively, as described below, the terminal performs random access by using CPE-dedicated random access resources (for example, CPE-dedicated RO resources on FWA-dedicated resources, CPE-dedicated ROs on non-FWA-dedicated resources, and/or CPE-dedicated preamble resources), so that the base station can know that the type of the terminal is CPE type. According to the terminal type, the base station determines whether to schedule the terminal to the FWA-dedicated resources. For example, for a CPE-type terminal, the base station schedules a part of resource (also referred to as first resource herein) among the FWA-dedicated resources (or resources of the first type) to the terminal.

The above-mentioned scheduling method for CPE-type terminals (hereinafter referred to as CPE) can be well compatible with the existing 5G NR protocol, but the delay of the overall procedure is long, and the base station cannot quickly identify the CPE trying to access, which makes the CPE stay on non-dedicated resources for a long time and cannot avoid large signaling overhead. Therefore, the above initial access and scheduling methods can be further adjusted for FWA-type services, and the initial access procedure can be improved to reduce signaling overhead and access delay.

### Embodiment 1-2

In this embodiment of the disclosure, the base station divides FWA-dedicated ROs on the FWA-dedicated resources, and CPE completes the selection of RO according to RO configuration information contained in the system information.

Specifically, the access procedure for a terminal (including CPE and non-CPE terminals) is as follows.

The terminal performs SSB search, and determines the time-frequency resources of the random access occasions according to the information in the Master Information Block (MIB) and/or the System Information Block in SSB.

Herein, the time-frequency resources of the random access occasions include the time-frequency resources of ROs for the non-CPE terminal and the time-frequency resources of CPE-dedicated ROs.

The terminal selects the time-frequency resource of RO according to its type, and completes the initial access on the same. For example, a CPE-type terminal can select the time-frequency resources of the CPE-dedicated ROs for initial trial access, so that it can implicitly inform the base station that the type of the terminal is CPE.

More particularly, the time-frequency resources of ROs for non-CPE terminal are located on non-dedicated resources, while the time-frequency resources of ROs dedicated to CPE are located on FWA-dedicated resources.

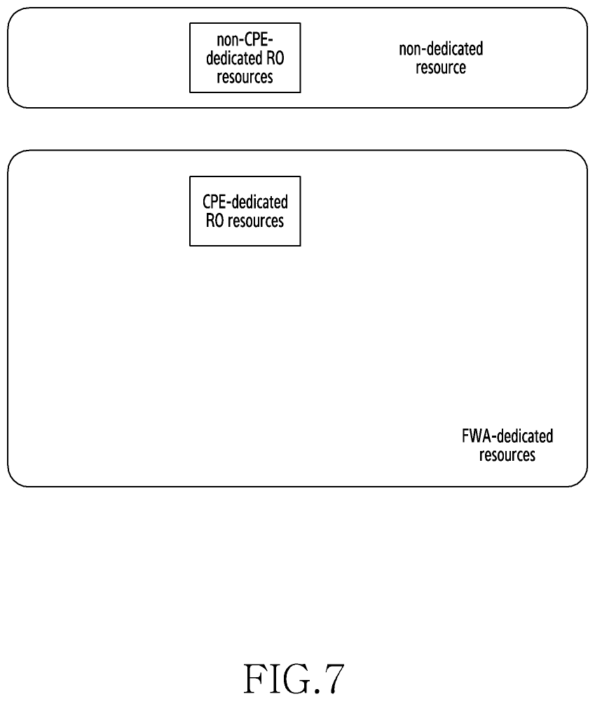

FIG. 7 illustrates a schematic diagram in which non-CPE-dedicated RO resources are located on non-dedicated resources and CPE-dedicated RO resources are located on dedicated resources according to an embodiment of the disclosure.

Referring to FIG. 7, according to the division between FWA-dedicated resources and non-dedicated resources, CPE-dedicated RO resources and non-CPE-dedicated RO resources can also be divided in frequency division or time division.

If RO resources are divided in frequency division, the frequency domain offset between CPE-dedicated RO resources and non-CPE-dedicated RO resources is informed in system information or high layer signaling, and the offset is in units of the number of physical resource block (PRBs) or the number of subcarriers. The terminal attempting to access obtains the frequency location of the CPE-dedicated RO resources through the start location of the frequency resources of ROs in the system information and the informed frequency offset.

Or, according to the start location of frequency resources of ROs in system information and the number of ROs in frequency domain, the end location of frequency resources of all ROs are known, and the frequency location of CPE-dedicated RO resources are known according to the end location and frequency offset.

If the RO resources are divided in time division, the time domain offset between the CPE-dedicated RO resources and the non-dedicated RO resources are informed in system information or high layer signaling, and the offset is in units of symbols, slots or mini-slots. The terminal attempting to access determines the time-domain start location of the non-dedicated RO resources through the slot index and the start symbol index in the random access configuration information in the system information, and obtains the time-domain start location of the CPE-dedicated RO resources according to the time-domain start location and the time-domain offset.

Or, according to the slot index, the start symbol index and the number of ROs in the slot in the random access configuration information in the system information, the end location of time domain resources of all ROs are known, meanwhile, the time domain start location of CPE-dedicated RO resources are known according to the time domain offset location.

In another way, the start time-frequency resources of CPE-dedicated RO resources can be obtained by combining the time-domain offset location and the frequency-domain offset location. Specifically, the time domain offset and frequency offset between dedicated RO resources and non-dedicated RO resources are informed to CPE in system information or high layer signaling. The terminal attempting to access determines the time-domain start location of non-dedicated RO resources through the slot index and the start symbol index in the random access configuration information in the system information, and determines the time-domain start location of CPE-dedicated RO resources according to the time-domain offset location, obtaining the frequency start location of the CPE-dedicated RO resources through the frequency start location of the ROs and the informed frequency offset in the system information.

Or the end time-frequency resource location of all non-dedicated RO resources are known through the configuration information in the system information, and the time-frequency start location of CPE-dedicated RO resources is known by combining time-domain offset and frequency-domain offset.

In another way, the terminal acquires the start time-frequency resource location of FWA-dedicated resources in system information or high layer signaling. Meanwhile, the time-frequency resource configuration information of CPE-dedicated RO resources is obtained from the system information, and the start location of CPE-dedicated RO resources is determined by frequency domain offset and/or time-frequency offset from FWA-dedicated resources.

After determining the time-frequency resources of the CPE-dedicated ROs, if the type of the terminal attempting to access is CPE, a preamble is transmitted on the time-frequency resources of the CPE-dedicated ROs, and subsequent random access procedure is performed on the FWA-dedicated resources.

Through the scheme in this embodiment of the disclosure, CPE can be quickly scheduled on FWA-dedicated resources, thus reducing the competition between CPE and non-CPE terminals, accelerating the access speed of CPE, and reducing the signaling overhead of CPE terminals.

### Embodiment 1-3

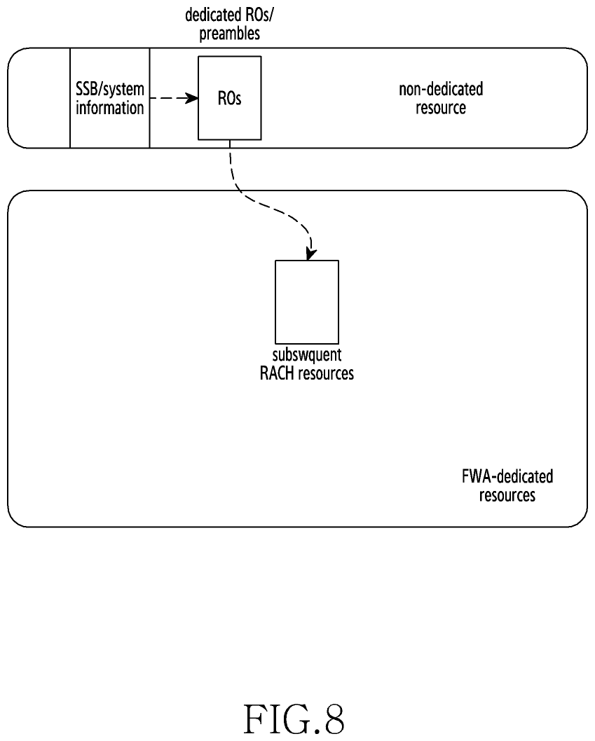

FIG. 8 illustrates a schematic diagram of allocating dedicated RO and/or preamble to a CPE-type terminal on non-dedicated resources according to an embodiment of the disclosure.

Referring to FIG. 8, in some embodiments of the disclosure, dedicated ROs and/or preambles may be allocated to CPE type terminals on non-dedicated resources, as shown in FIG. 8.

The specific procedure is as follows.

The terminal attempting to access obtains the configuration information related to initial access through the broadcast channel and system information in SSB, and obtains the information on dedicated ROs and/or preambles used for CPE type terminal access.

For CPE-type terminals, the preamble is transmitted in a dedicated RO and/or using a dedicated preamble.

Receiving RAR, and performing subsequent random access procedure on FWA-dedicated resources.

Herein, for dedicated ROs, it can be completed by informing the index of CPE-dedicated RO resources in system information or high layer signaling, for the dedicated preambles, CPE-dedicated preamble index or index set can be informed in system information or high layer signaling. The index set may be the start index and the number of preambles of the CPE-dedicated preambles, or the start index and the end index, or the index set of the CPE-dedicated preambles is directly informed.

Herein, after the CPE type terminal completes the transmission of the preamble, the subsequent random access procedure may include the following steps.

The first possible step is that the terminal monitors the RAR on the common control channel on the FWA-dedicated resources. Herein, the terminal obtains the location of time-frequency resource of common control channel on the FWA-dedicated resources in the system information. The obtaining of the location of time-frequency resources of common control channel includes the location of time-frequency resources of common control channel on FWA-dedicated resources is directly informed in system information, or the frequency offset relative to common control channel on non-dedicated resources is informed, and the terminal obtains the location of time-frequency resources of common control channel on FWA-dedicated resources by obtaining the location of time-frequency resources of common control channel and the frequency offset in the system information, or the terminal obtains the start location of time-frequency resources of the FWA-dedicated resources and the frequency offset of common control channel relative to the start location of time-frequency resources of the FWA-dedicated resources in the system information, to obtain the location of time-frequency resources of common control channel on the FWA-dedicated resources.

The terminal monitors and receives the RAR directly on the FWA-dedicated resources, and the subsequent random access procedure is performed on the FWA-dedicated resources.

The second possible step is that the terminal monitors the RAR on the common control channel on the non-dedicated resources, obtains the location of time-frequency resources of the FWA-dedicated resources in the RAR, and performs the subsequent random access procedure on the FWA-dedicated resources. Alternatively, the location of time-frequency resources of FWA-dedicated resources may also be informed in system information or high layer signaling.

Through the solution described in this embodiment of the disclosure, compared with the previous embodiment, because there is no need to pre-allocate resources on FWA-dedicated resources, the introduced overhead is lower.

### Embodiment 1-4

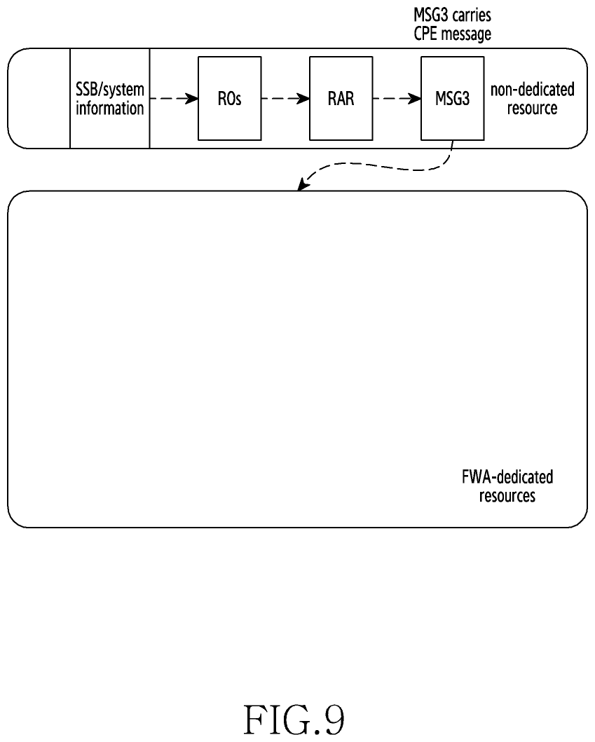

FIG. 9 illustrates a schematic diagram of a CPE type terminal transmitting CPE type indication when transmitting a message 3(msg3) according to an embodiment of the disclosure.

Referring to FIG. 9, in some embodiments of the disclosure, if the terminal type is CPE, the terminal may transmit a CPE type indication when transmitting message 3, as shown in FIG. 9.

The specific procedure is as follows.

The terminal attempting to access obtains the initial access-related configuration information through the broadcast channel and system information in SSB, transmits the random access preamble on the non-dedicated resources, receives the RAR on the non-dedicated resources, and transmits the subsequent message 3.

If the type of the terminal attempting to access is CPE, the message 3 carries the indication information of CPE type.

The terminal of CPE type receives the contention resolution message on the FWA-dedicated resources to complete the initial access.

Herein, carrying the indication information of CPE type in message 3 includes adding a 1-bit indication bit in the MAC message of message 3 to indicate whether the terminal type is CPE.

Herein, the terminal of CPE type receiving the contention resolution message on the FWA-dedicated resources, includes, receiving indication information on the location of time-frequency resources of common control channel on the FWA-dedicated resources when the terminal receives the system information. After transmitting message 3, the CPE type terminal receives the contention resolution message on the common control channel on the FWA-dedicated resources.

Or, after transmitting message 3, the terminal still monitors the subsequent downlink control channel on the non-dedicated resources, wherein the downlink control channel will carry the time-frequency location of the contention resolution message in the FWA-dedicated resources. The time-frequency resource location may be a PRB index and/or a slot index directly indicating the time-frequency resource location, or a relative time and/or frequency index relative to the start time-frequency location of the FWA-dedicated resources. The terminal obtains the location of time-frequency resources of the contention resolution message in the FWA-dedicated resources, obtains the contention resolution message in the corresponding time-frequency resources, and completes the initial access.

Or, the contention resolution message is still received on the non-dedicated resources, and the contention resolution message also carries the time-frequency resource location information of the FWA-dedicated resources to directly schedule the CPE type terminal to the FWA-dedicated resources.

Because there is no need to pre-allocate resources to initial access on the FWA-dedicated resources, the method provided by the present solution can reduce the overhead brought during the initial access process.

### Embodiment 1-5

In some embodiments of the disclosure, due to issues, such as competition or channel environment, a CPE type terminal fails to complete random access after transmitting message 3, and the terminal need to re-initiate random access. The possible ways are as follows.

The terminal transmits message 3 according to the scheduling information in the RAR.

The terminal detects downlink control information related to its own temporary terminal identification in the common control channel, and detects a contention resolution message carried in the downlink control information.

If the contention resolution message matches the terminal identification, it means that the contention resolution for the terminal is successful and the initial access is successfully completed.

If the contention resolution message does not match the terminal identification, it means that the terminal failed in the conflict and needs to adjust the transmission power and re-perform random access.

If the contention resolution message does not contain any terminal identification, but indicates the location of time-frequency resources of ROs for subsequent random access, the terminal failed in the conflict, and re-performs random access on the ROs newly allocated by the base station after adjusting the transmission power.

Herein, the terminal type identification of CPE has been transmitted or the CPE type indication information has been informed of the base station for the above random access procedure through the solution in the previous embodiments, the base station has obtained that there is a CPE type terminal tried to access through the random access procedure. ROs reallocated by the base station is located on the FWA-dedicated resources.

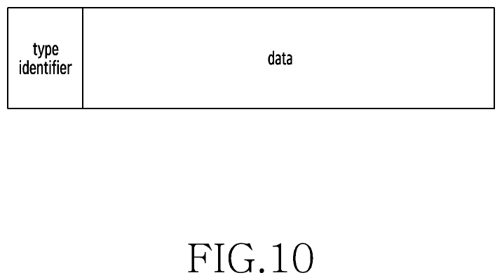

A possible structure of the aforementioned contention resolution message is shown in FIG. 10.

FIG. 10 illustrates a structure of a contention resolution message according to an embodiment of the disclosure.

Referring to FIG. 10, where the type identifier is used to explain the type of the subsequent data, one possible way is that 0 indicates that the subsequent data is a contention resolution scheme, and 1 indicates that the subsequent data is the time-frequency resource location of the reallocated ROs. The terminal receiving the contention resolution message may decide whether the contention resolution message is used for contention resolution or for informing the reallocated RO resources according to the type identifier.

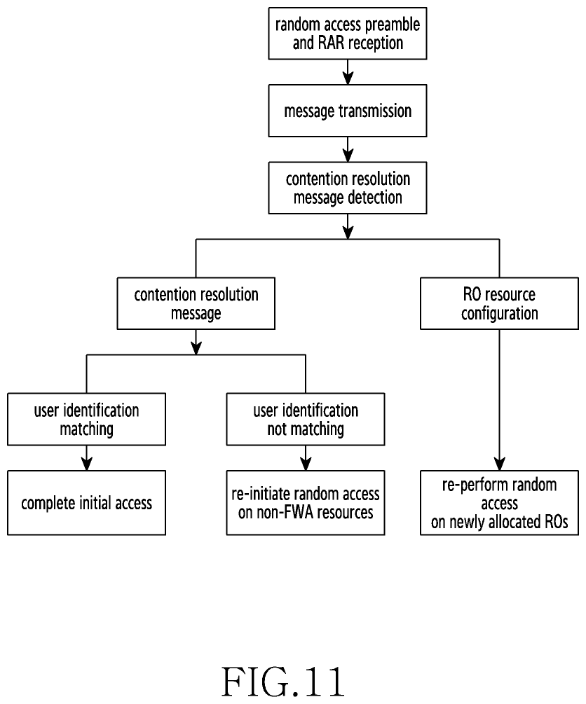

The aforementioned terminal behavior is shown in FIG. 11.

FIG. 11 illustrates a terminal behavior according to an embodiment of the disclosure.

Referring to FIG. 11, if the random access initiated by the CPE type terminal on the reallocated ROs still fails, the terminal may behave as follows:
the terminal re-initiates random access procedure on ROs on non-dedicated resources; or
the terminal obtains the effective/valid time of the reallocated ROs according to configuration information of the reallocated RO resources, and if the ROs are still within the valid time, the reallocated ROs are still used to initiate random access, otherwise, the ROs on the non-dedicated resources are used by the terminal to re-initiates the random access procedure.

Herein, the valid time of ROs can be informed by absolute time, and the timing starts when the terminal receives the corresponding configuration, or the timing starts when the terminal uses the reallocated ROs to transmit preamble.

Another possible way to configure the valid time of ROs is to configure or transmit the number of valid slots in RO configuration information. The terminal starts to count the number of valid slots after receiving the RO configuration information.

Another possible way to configure the valid time of ROs is to configure or transmit the number of valid ROs in the RO configuration information. The terminal starts to count the number of valid ROs after receiving the RO configuration information.

### Embodiment 1-6

In some embodiments of the disclosure, the CPE type terminal has some prior information including timing advance, SSB index due to the previous access. When such CPE terminal performs access, these already obtained timing advance and SSB index may be used for quick access.

The specific procedure is as follows.

CPE performs SSB search and detection, and measures and detects the SSB corresponding to the SSB index used in the previous access. If the measured reference signal received power (RSRP) is greater than a preset threshold, it determines that the previous information is usable and reads the location of reserved time-frequency resources in the SSB.

At the location of the above-mentioned time-frequency resources, an access request is transmitted by using the previously used timing advance. The access request at least includes user identification information.

After the terminal transmits the access request, it detects the downlink control information on common control channel, and determines whether the access is successful according to the content in the downlink shared channel indicated by the downlink control information (for example, the contention resolution message, the structure of which is shown in FIG. 10, for example).

If the information in the downlink shared channel matches the user identification information, the access is successful.

If the information in the downlink shared channel is RO resource allocation information, it means that the access failed, and CPE transmits preamble on the reallocated ROs. This process may be similar to those described in connection with FIGS. 10 and 11, and will not be described here.

The aforementioned reserved time-frequency resources can be on non-FWA-dedicated resources or on FWA-dedicated resources.

Herein, the aforementioned reallocated ROs are on the FWA-dedicated resources.

By the above method, the information obtained during the previous random access procedure can be fully utilized, so that the subsequent random access procedure can be simplified, the time delay can be reduced, and the terminal can access the base station more quickly.

### Embodiment 2-1

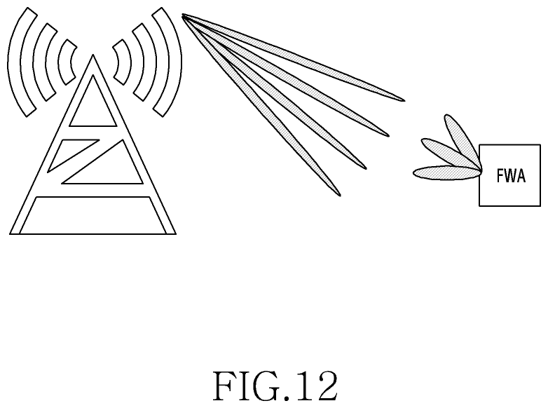

FIG. 12 illustrates a schematic diagram of beams of a base station and a terminal according to an embodiment of the disclosure.

Referring to FIG. 12, when the terminal has data transmission requirements, initial access is first performed to obtain available pair of transmit and receive beam. Thereinto, the transmit beams carrying broadcast signal at base station are periodically swept in different directions, and the transmitted content is SSB (synchronization signal/PBCH block), and different SSBs in a period are distinguished by SSB index. The terminal periodically attempts to receive in different directions through different receive beams, as shown in FIG. 12. Thereinto, the different transmit beam directions of the base station correspond to SSB index one by one, where the receive beam direction of the terminal is related to the codebook used by the terminal, for example, it corresponds to the receive beam (rx beam) used by the terminal one by one. If the RSRP (reference signal receiving power) measured by the terminal on an SSB meets the threshold condition (for example, RSRP>threshold power), it is considered that the SSB meets the transmission requirements. The terminal thinks that the receive beam and the beam corresponding to the SSB sent by the base station can be used as a beam pair for communication with the base station, and completes downlink timing synchronization based on the measurement or test results of SSB. The synchronization information in SSB (for example, primary synchronization signal (PSS) and/or secondary synchronization signal (SSS)) includes cell physical ID (PCID, cell ID) information, the system information in the broadcast channel (PBCH) in SSB includes SSB index, random access occasion (RO) location information (e.g., time-frequency resource information), or the like. The terminal sends a preamble (also called msg1) to the base station through the PRACH channel (physical random access channel) by using the receive beam used by the terminal on the RO time-frequency resource associated with the SSB, and uses the receive beam to receive the random access response information (RAR, also called msg2) sent by the base station. It should be understood that it can be assumed that the channels are reciprocal, and the receive beam used by the terminal is also used for the uplink transmit beam.

In the disclosure, when the type of the terminal connected with the base station is CPE, the transmission path of the beam for communication between the base station and CPE changes little, and when there is a new communication demand, CPE can refer to the information used in the previous connection with the base station, thus simplifying the receiving and measuring and/or beam management process for the SSB for connecting with the base station, shortening the connection time and reducing the signaling overhead. Wherein, the information about the previous connection with the base station may be the information when the CPE was in RRC-connected state for the latest time.

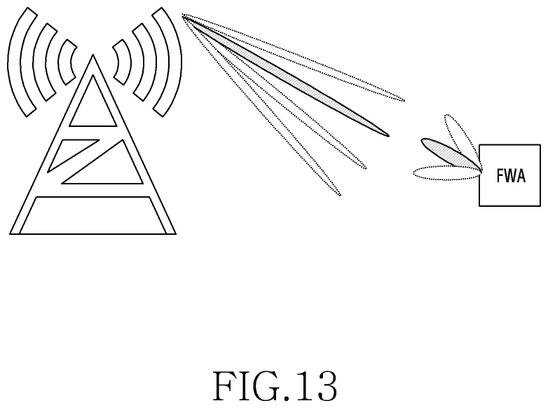

FIG. 13 illustrates a schematic diagram of beams used by the base station and CPE for SSB transmission and reception according to an embodiment of the disclosure.

Referring to FIG. 13, in some embodiments of the disclosure, when there is a new connection requirement, the beam pair previously used by CPE may still meet the transmission conditions, so CPE can initiate a random access request to the base station directly based on the previous SSB-related information (including at least one of: RO related time-frequency resources, SSB index, and cell ID) after completing downlink synchronization through the measurement of SSB, without reading all the information in SSB. In this disclosure, previous information (which may include previous SSB-related information, for example) may also be called historical information or previous identified available sets. As shown in FIG. 13, CPE measures SSB with the receive beam used previously, completes downlink synchronization based on its measurement results, and directly sends the preamble (msg1) of random access request on the RO time-frequency resources associated with previous SSB, and the direction of the transmit beam is the same as that previously. The base station receives msg1 sent by CPE, and determines the beam used to send msg2 according to the RO location information. If the same user requests access using the same RO resource, the base station can identify the user using the RO resource through subsequent msg3 and msg4, or the base station can determine the terminal type as CPE based on specific information and preferentially allocate the RO resource to CPE. Thereinto, the specific information can be terminal type indication information sent by CPE, or dedicated resource information used by CPE (for example, CPE dedicated RO, CPE dedicated preamble). During this process, CPE only obtains downlink synchronization related information (for example, including at least one of radio frame timing, half frame timing, slot timing, symbol timing, or the like) by measuring SSB, without parsing other information contained and indicated in SSB, which greatly shortens the connection time with the base station and reduces the signaling overhead.

Optionally, in order to avoid the power of the beam reaching CPE associated with previous SSB for connection by CPE not continuing meeting transmission requirement due to the change of transmission environment, CPE can judge whether the beam associated with the SSB can continue to be used as the connection beam before directly initiating random access using the information stored previously. For example, based on the measurement result of the SSB, if the measured RSRP of the SSB still meets the transmission requirements (for example, RSRP>threshold power), it is determined that the beam associated with the SSB can continue to be used as a connection beam, and CPE can continue to directly initiate random access using the information stored previously. If the measured RSRP of the SSB does not meet the transmission requirements (for example, RSRP<threshold power), it is determined that the beam associated with the SSB cannot continue to be used as the connection beam. CPE needs to try again to detect the SSB that meets the transmission conditions, read the relevant information carried and indicated in the SSB, and initiate random access based on the information.

Optionally, a higher data transmission rate can be obtained by using the beam pair with the maximum transmission gain between CPE and base station communication, and the beam pair with the maximum transmission gain may change with the change of transmission environment. In the process of SSB measurement and selection by CPE, the transmit beam of base station corresponding to the first SSB that meets the transmission conditions may not be the beam with the maximum transmission gain, so CPE can be configured with the priority of SSB selection to improve the probability of finding a high-gain beam pair and improve the information transmission rate. For example, CPE can be set to give priority to the SSB used in the previous connection, that is, in the process of SSB measurement and selection, when CPE receives the SSB meeting the transmission conditions (such as RSRP>threshold power) within a certain time T1, it reads the identity-related information (such as SSB index and cell ID) of the SSB and makes a judgment. Thereinto, the related information for setting SSB selection priority can be sent by other nodes (such as base stations) or stored in CPE in advance. If the measured SSB meeting the transmission conditions is the same as the SSB identity information used previously, CPE completes downlink synchronization based on the SSB information, and directly performs random access based on the previous data, If the measured SSB that meets the transmission conditions is different from the SSB identity information used previously, CPE will not directly use the information carried by the SSB to connect with the base station, but will continue to receive and measure SSB until it finds an SSB that meets the transmission conditions and is the same as the SSB identity information used previously. If the beam with the same identity information as the SSB used previously is not measured within time T1, or the beam is measured but does not meet the transmission conditions (for example, RSRP<threshold power), CPE can select another SSB-related beam that meet the transmission conditions as the beam for connection, for example, the first SSB that meets the transmission conditions measured by CPE within the time period T2 after time T1 (for example, T2 is less than or equal to T1), and complete random access based on the information carried and indicated by the SSB.

Optionally, if the CPE does not receive the random response information sent by the base station within a certain time T3 after sending msg1 using the previous SSB-related information, the CPE can re-detect an SSB and initiate a random access procedure based on the information carried and indicated by the SSB that meets the transmission conditions. Wherein, the time T3 may be the time in which the CPE increases the power for many times to send msg1 and tries to receive the random access response information from the base station, and/or the time in which the CPE tries to receive the random access response information sent by the base station using multiple beams. Or, CPE receives the random access response information sent by the base station, but fails to connect to the base station in the subsequent contention process, CPE can re-detect SSB and initiate random access procedure based on the information carried and indicated by the SSB that meets the transmission conditions.

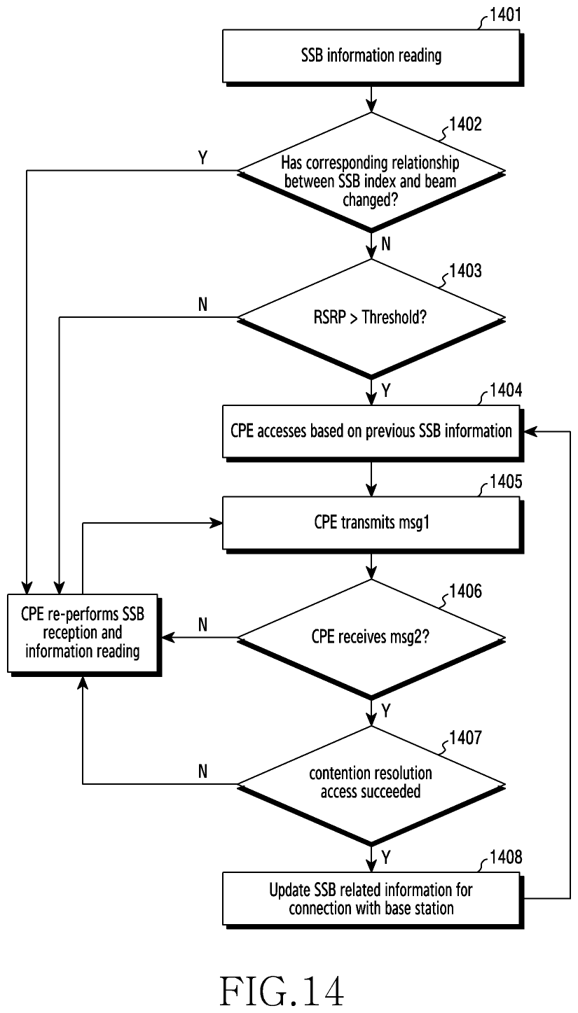

Optionally, CPE can try one or more of the above methods to receive SSB sent by the base station and obtain SSB-related information carried therein, complete downlink timing synchronization according to the information carried therein, send a preamble of random access on the RO time-frequency resource associated with the SSB, and try to receive the access response information sent by the base station to realize the connection with the base station. In the embodiment shown in FIG. 14, the specific sequence and methods of combining the above methods are explained by examples.

FIG. 14 illustrates a schematic diagram of a method according to an embodiment of the disclosure.

Referring to FIG. 14, according to the method of the embodiment of the disclosure, random access procedure between CPE and the base station includes at least some of the following operations 1401-1409:
Operation 1401: CPE performs SSB information reading;
Operation 1402: CPE determines whether the corresponding relationship between SSB index and beam will change;

If the result of determination in operation 1402 is that the corresponding relationship between SSB index and beam will not change, proceed to operation 1403.

In operation 1403, CPE determines whether the signal quality (for example, RSRP) measured for SSB is greater than a threshold.

If the result of determination in operation 1403 is that the signal quality is greater than the threshold, proceed to operation 1404: CPE performs random access based on previous SSB information; and operation 1405: CPE sends message 1(msg1).

In operation 1406, CPE determines whether Message 2(msg2) has been received.

If it is determined in operation 1406 that msg2 is received, it is determined in operation 1407 whether the contention is resolved and whether the access is successful.

If it is determined in operation 1407 that the access is successful, the SSB-related information for connection with the base station is updated in operation 1408.

If the result of determination in operation 1402 is that the corresponding relationship between SSB index and beam will change, the result of determination in operation 1403 is that the signal quality is not greater than the threshold, it is determined in operation 1406 that msg2 is not received, or it is determined in operation 1407 that the access is unsuccessful, then perform operation 1409: CPE performs SSB reception and information reading again.

According to the flow chart shown in FIG. 14, CPE tries to receive SSB-related information carried in the beam sent by the base station before initiating random access. If the beam with the same identity information as that of the SSB used previously can be received within time T1 and the transmission conditions are met (for example, RSRP>threshold power), CPE sends a random access request on the same RO time-frequency resource used previously based on the previous information. If the beam with the same identity information as that of the SSB used previously is not received within time T1, CPE can select the beam associated with the Nth SSB (for example, N=1) that meets the transmission conditions and send a random access request on the RO time-frequency resource related to the SSB carried by this beam. If CPE cannot receive the random response information sent by the base station within a certain time T3 after sending msg1 using the previous SSB-related information, it can re-detect the SSB that meets the transmission conditions and initiate random access procedure based on the information carried and indicated therein.

If the corresponding relationship between the SSB identity information and the actual beam at the base station will change, for example, the surrounding environment of the base station will change, the beam transmission direction corresponding to the same SSB index in the same cell will change, and the transmission path for the connection between the beam with the same SSB identity information obtained by CPE during SSB reception and measurement and the CPE will change greatly. At this time, the reference significance of the information related to previous connection of CPE to the actual transmission path is weakened, the success probability of a random access procedure continuing to use the previous information is reduced, and additional time and signaling overhead will be introduced if continuing to use relevant parameters to try random access. Therefore, it is necessary to determine whether the corresponding relationship between the SSB index and the actual beam will change at the base station, that is, whether the existing transmission path is consistent with the transmission path when recording the data in the data list, before performing a random access by CPE using the previous SSB-related information.

Optionally, whether the corresponding relationship between the SSB index and the actual beam will change can be notified to CPE by other nodes, for example, the base station sends indication information to inform CPE that the corresponding relationship between the SSB index and the actual beam will change, and the indication information can be stored in SSB. The indication information can be stored in SIB1. CPE needs to parse MIB information carried in SSB, and parse corresponding SIB information based on the indication information in MIB, so as to obtain the indication information of whether the corresponding relationship of SSB index will change. Alternatively, the indication information can be stored in MIB, and CPE only needs to analyze the MIB information carried in SSB to obtain the indication information of whether the corresponding relationship of SSB index will change. The indication information may be in the form of 2 bits, which defines the time point when the corresponding relationship between SSB index and beam will change in a long time period. Based on such time information, CPE determines whether the previous connection information stored by CPE is consistent with the corresponding relationship of SSB received this time.

Optionally, whether the corresponding relationship between the SSB index and the actual beam will change can be judged by CPE based on specific test data and specific rules. For example, the judgment based on test data can be realized by monitoring the measured transmission loss value of the transmission path from the base station to the CPE. If the amount in change of the transmission path loss exceeds a specific threshold (for example, x % of the previous measurement value of transmission path loss, the percentage value can be configured by other nodes or stored in the CPE in advance), it is determined that the corresponding relationship between the beam of the base station and the SSB index will change, and the threshold can be configured by other nodes (such as through RRC) or stored in the CPE node in advance. The calculation of transmission path loss can be obtained by calculating the difference between the power value of designated signal received by CPE and the transmission power value, where the transmission power value can be informed by the transmitting node (e.g. base station). If the power value of the designated signal sent by the base station is a fixed value, the monitoring value that CPE judges whether the SSB corresponding relationship at the base station will change can be the received power value of the designated signal, and the transmitted power value is directly stored in the CPE node without additional signaling, so as to reduce the signaling overhead.

Optionally, if the threshold for determining whether the transmission path will change is related to the long-term statistical value (e.g., average value) of the transmission loss during transmission of the path, for example, the threshold is x % of the long-term statistical value of the transmission loss, the identification information (e.g., cell ID and SSB index) of the transmission path and the data of the statistical value of the transmission loss can be maintained at CPE, and the statistical value is updated every time the same transmission path (i.e., the same cell ID and SSB index) is used to access the base station. Thereinto, the calculation of statistical value in each update is related to the previous statistical value P1 (the numeral value in the statistical table) and the current measured value Pi, for example, it can be the weighted average of the statistical value P0 and the current measured value Pi (a*Pi+(1−a)*P1). The calculation method for the statistical value can be obtained from other nodes (for weighting factor a) or stored in the storage structure of CPE in advance.

TABLE 1

| Cell ID | SSB index | Statistical power value |
|---|---|---|
| X1 | Y1 | P1 |
| | Y2 | P2 |
| X2 | Y3 | P3 |

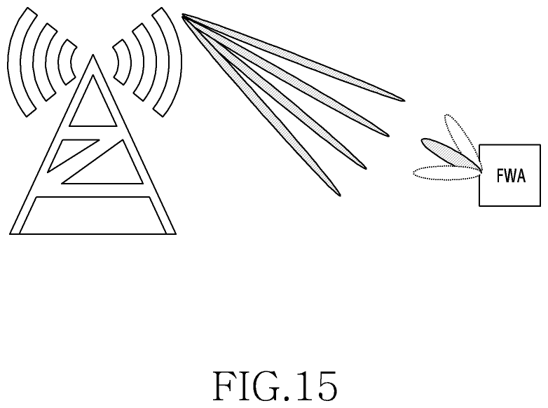

FIG. 15 illustrates a schematic diagram of receiving SSB by CPE using previously used beam according to an embodiment of the disclosure.

Referring to FIG. 15, optionally, in some cases, the transmission environment from the base station to the CPE will change slightly (for example, the channel fading will change due to weather changes), and the beam pair connected between the base station and the CPE used previously may no longer meet the transmission requirements, but the spatial relative position of the base station and the CPE will not change much, and the beam pair used for connection may be the related beam pair of the beams used previously (for example, other beams with the direction close to the beam associated with SSB used previously). At this time, CPE can directly use the previously used receive beam for SSB reception without sweeping for the receive beams, so as to obtain an available beam pair and shorten the time for SSB reception process, as shown in FIG. 15. When a CPE receives an SSB that meets the transmission conditions (for example, RSRP>threshold power), it can obtain the information carried in the SSB, complete downlink synchronization based on the information indicated by the SSB, initiate random access procedure on the time-frequency resources related to the RO of the SSB, re-establish connection with the base station, and shorten the time required for connection with the base station.

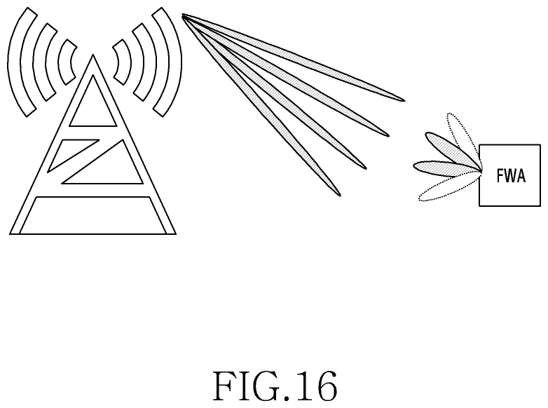

FIG. 16 illustrates a schematic diagram of receiving SSB by CPE using a beam related to previously used beam according to an embodiment of the disclosure.

Referring to FIG. 16, optionally, if SSB reception and measurement are carried out by using the CPE receive beam used previously, and the SSB-related beams meeting the transmission conditions cannot be found within a certain time T3, CPE can try to sweep with multiple receive beams in different directions for receiving SSB sent by the base station, so as to find available beam pair for connection with the base station. The time T3 can be the time required for one cycle of SSB (for example, SSB sweep period*number of SSB sweeps), and it can be obtained by at least one of the following methods: it is configured by other nodes (for example, through RRC, by base station), pre-stored in the storage unit of CPE, and calculated based on the information stored by CPE and/or obtained from other nodes. Thereinto, the beams in different directions can be a beam set covering the service range of CPE, or a plurality of receive beams related to the beam directions used previously. For example, as shown in FIG. 16, CPE uses multiple receive beams adjacent to the beam direction used previously, so as to improve the probability of successfully receiving SSB, but it is not necessary to receive SSB in all receive beam directions within the service range of CPE, thus shortening the sweep period of receive beams and reducing the time required for successfully accessing the base station.

In the disclosure, the application of CPE to millimeter wave system can simplify the process of beam management, and narrow the range of beam sweep according to the beam information of previous connection, or combine the beam sweep process with the SSB receiving and measuring process to reduce the number of periods of beam sweep, so as to reduce the time and signaling overhead of beam management. In some embodiments of the disclosure, CPE directly tries to receive SSB information in the beams sent by the base station by using the narrow beam used previously. If an SSB can be successfully received, CPE completes downlink timing synchronization and random access procedure based on the information carried in the SSB. In the subsequent beam management process, it only needs to complete the reception, measurement and reporting of measurement results of a plurality of narrow beams sent by the base station, so as to obtain a high-gain narrow beam pair for data transmission. Thereinto, during the narrow beam sweep and measurement at the base station side, the base station can send different CSI-RS and configure the CPE with measurement and report of the CSI-RS. CPE measures CSI-RS according to the configuration signaling and reports CSI-RS identity information (CSI-RS index) and corresponding measurement result (for example, RSRP (reference signal receive power)) to determine the narrow transmit beam for communication between the base station and CPE. Thereinto, the content reported by CPE includes CSI-RS index, which corresponds to narrow beams in different directions one by one. Compared with the traditional method, the using of narrow beam of CPE directly for SSB reception, measurement and/or random access procedure, shortens the time for sending beam sweep configuration signaling for CPE, beam sweep at CPE side and measuring the swept beam at base station during the beam management process, and reduces the related signaling overhead and time cost.

In some embodiments of the disclosure, due to the small coverage of millimeter wave narrow beam, directly using narrow beam by CPE for SSB reception and measurement may lead to the failure to successfully receive the beam carrying SSB information sent by the base station. In order to improve the probability of successfully receiving SSB during SSB reception and measurement, CPE can use wide beam for SSB reception. If the SSB sent by the base station selected by CPE is the same as the identity information of SSB used previously (the same SSB index and cell ID), CPE can use the high-gain narrow beam used when disconnecting when sending the random access request, so as to shorten the signaling overhead and time of narrow beam selection for CPE in the subsequent beam management process and improve the resource utilization rate.

Optionally, CPE can store and manage the beam information used every time it successfully completes random access with the base station, besides using the beam used previously. When CPE receives and measures SSB and obtains the information carried in SSB, it can judge whether the SSB is a beam connected previously by retrieving the stored file. If the SSB is a beam connected previously (SSB identity information is consistent), CPE can retrieve and determine the beam used when CPE successfully connected previously in the stored file, and CPE can try to directly use this beam for random access procedure. The stored file can be in the form of a table, as shown in Table 2 below. The stored information can include SSB identity information (SSB index), base station identity information (cell ID) and narrow beam information for CPE (receive beam index, receive beam codebook, or receive beam codebook index).

TABLE 2

| Cell ID | SSB index | Receive beam index |
|---|---|---|
| X1 | Y1 | Z1 |
| | Y2 | Z2 |
| X2 | Y3 | Z3 |

Optionally, CPE can record the number of times corresponding to using a transmit beam index when successfully completing random access with the base station in the data record file, and when retrieving the record file to determine the receive beam used by CPE, a receive beam index with the most number of times of successful connection using the receive beam index corresponding to the cell ID and SSB index is preferentially selected, as shown in Table 3 below. When the cell ID obtained by CPE during SSB reception and measurement is X1 and SSB index is Y1, if N1>N2, CPE uses the receive beam with the receive beam index of Z1 to perform random access procedure.

TABLE 3

| Cell ID | SSB index | Receive beam index | Number of times |
|---|---|---|---|
| X1 | Y1 | Z1 | N1 |
| | Y2 | Z2 | N2 |
| X2 | Y3 | Z3 | N3 |

Optionally, when the corresponding relationship between the SSB index and the actual beam at the base station will change, the transmission between the beam with the same SSB identity information obtained by CPE during SSB reception and measurement and the CPE for connection will change greatly, and the reference significance of the relevant information of previous connection of the CPE to the actual transmission path is weakened at this time. Therefore, if it is determined that the corresponding relationship between SSB index and the actual beam at the base station will change before the random access of CPE using the SSB-related information previously used, the table recording the receive beam index used when successfully completing random access with the base station will be zeroed.

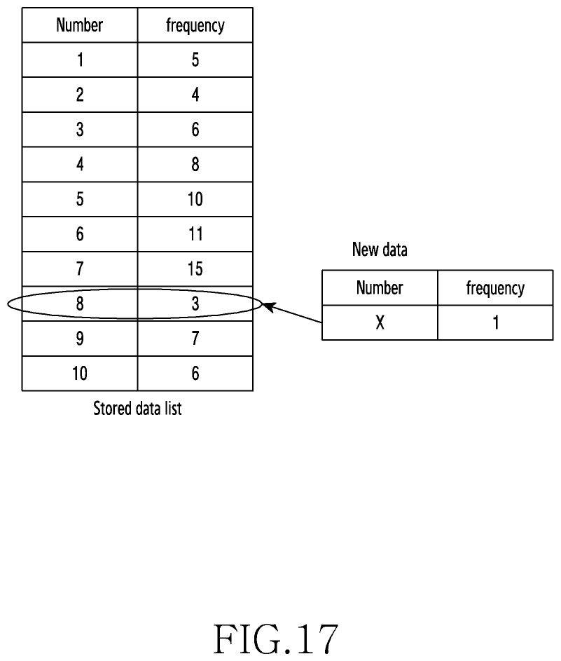

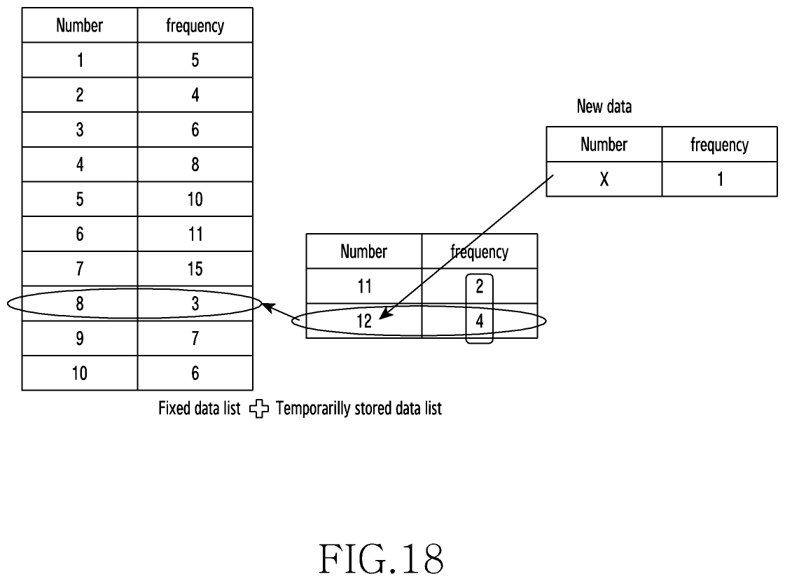

FIGS. 17 and 18 illustrate schematic diagrams of CPE storing SSB-related data according to various embodiments of the disclosure.

Referring to FIGS. 17 and 18, optionally, because the relative spatial position between CPE and the base station will change little, the number of receive beams for CPE that meet the transmission conditions is limited, in order to reduce the space occupied by storing the above-mentioned beam corresponding relationship file, the number of stored information can be limited. Thereinto, the limited number can be at least one of: the total number of stored cell IDs, the total number of stored SSBs (distinguishing different cell IDs), the number of SSBs corresponding to a single cell ID, the total number of receive beams (distinguishing different cell IDs, different SSBs), the number of receive beams corresponding to a single SSB, and the total storage space. For example, as shown in the embodiment of FIG. 15, the total number of SSBs commonly used for CPE storage and management is limited to ten. When new SSB data needs to be stored, the SSB corresponding data with the least total usage (including different receive beams) is directly overwritten with the data corresponding to the new SSB. In the embodiment of FIG. 17, SSB numbered X overwrites the data numbered 8 with the lowest frequency in the original stored list.

In some cases, the new SSB may be a beam connected accidentally. For example, the movement of objects on the transmission path causes the signal to reflect and be superimposed and enhanced at some moments, the probability of this scene is small, and the frequency used may be lower than that of the overwritten SSB. Therefore, a temporary stored list of SSB data can be designed. If new SSB-related data need to be stored, the new SSB-related data will not be directly overwritten the original SSB data, but will be stored in the temporary stored list for continuous recording, and overwrites the original SSB with the least usage under certain condition. The condition may be: the number of times the SSB is used within a certain period of time, or there is a new SSB data to be recorded. The period of time can be configured by other nodes or stored in CPE in advance, and the threshold for comparing with the number of times can be a specific value configured by other nodes or stored in CPE in advance, or the total number of times the original SSBs are used. In the embodiment shown in FIG. 18, the list to be maintained by CPE includes a fixed data list and a temporary data list, with the maximum number of storage for the fixed data list being 10 and the maximum number of storage for the temporary data list being 2. If there is new SSB data to be recorded (numbered X) and the temporary data list is full, it is necessary to compare the data with the highest frequency in the temporary data list (numbered 12) with the data with the lowest frequency in the fixed data list (numbered 8). If the frequency of use of the data with the highest frequency in the temporary data list (numbered 12) is greater than that of the data with the lowest frequency in the fixed data list (numbered 8), then the data with the highest frequency (numbered 12) in the temporary data list overwrites the original data with the lowest frequency (numbered 8), and the relevant information of new data (numbered X) is recorded in the temporary data list, overwriting the data with the highest frequency (numbered 12) in the original temporary data list, and the information related to frequency of usage of new data is continuously recorded.

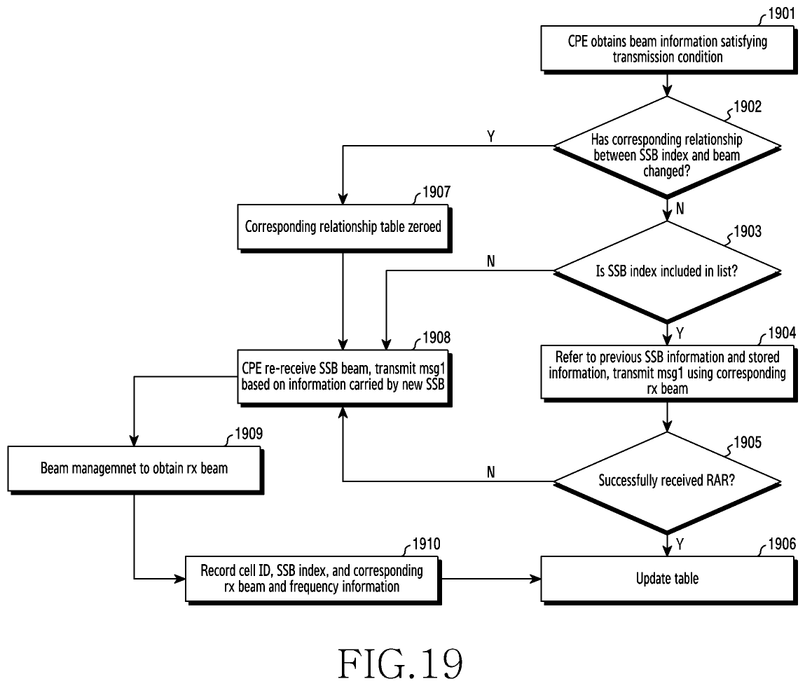

If the CPE is a newly established network node, and there is no previous connection data with the base station as a reference, or if the CPE is not a newly established network node, but the corresponding relationship between SSB index and the actual output beam will change for it, the data information stored previously is invalid. The selection of beams for connection between the CPE and the base station needs to be obtained by sweeping of the transmit and receive beams, respectively. The CPE records the narrow beam information determined by the beam management selection process after its successful connection and updates it to the statistical list. The specific procedure is shown in FIG. 19.

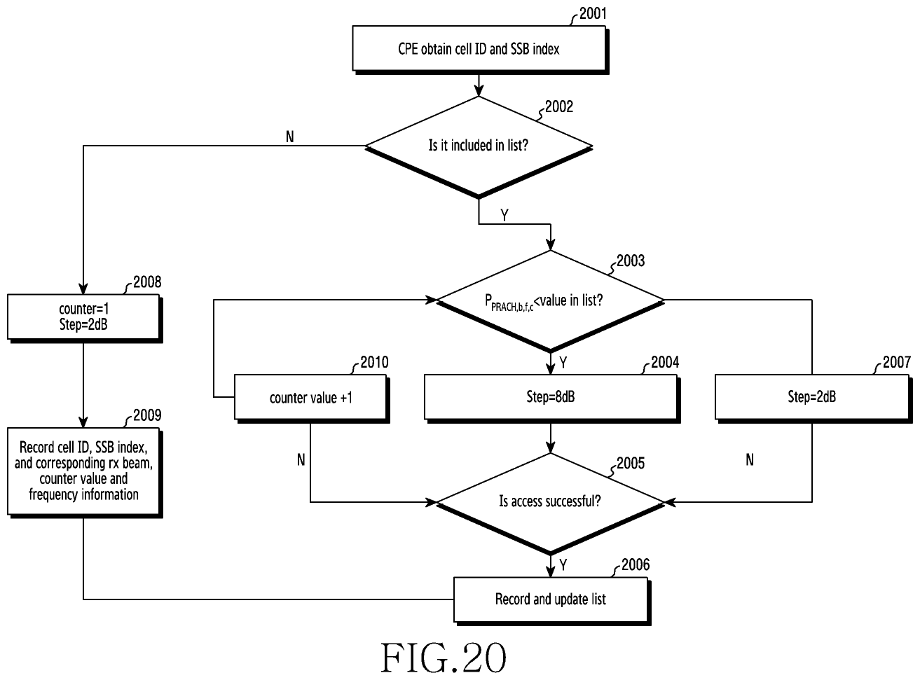

FIGS. 19 and 20 illustrate schematic diagrams of methods according to various embodiments of the disclosure.

Referring to FIG. 19, according to the method of the embodiment of the disclosure, random access procedure between CPE and the base station includes at least some of the following operations 1901-1910:

Operation 1901: CPE obtains beam information of SSB index meeting transmission conditions;

Operation 1902: CPE determines whether the corresponding relationship between SSB index and beam will change;

If it is determined in operation 1902 that the corresponding relationship between SSB index and beam will not change, proceed to operation 1903: CPE determines whether the SSB index is included in a list in which SSB previously used by CPE and some information corresponding to SSB (such as information carried or indicated in SSB, RO location, TA, receive beam, value related to power adjustment related to PRACH transmission, and the number of successful random access using the SSB) are stored.

If it is determined in operation 1903 that the SSB index is included in the list, then perform operation 1904: CPE refers to the previous SSB information and stored information to transmit msg1 using the corresponding receive beam, and operation 1905: CPE determines whether the random access response (RAR) is successfully received.

If it is determined in operation 1905 that the RAR is successfully received, then perform operation 1906: update the table corresponding to the above list (for example, it can also be called “corresponding relationship table”), for example, the table includes a list of SSB indexes, and each row includes SSB index and information corresponding to the SSB index, including some information during the successful random access procedure conducted by CPE based on the SSB previously, for example, information carried or indicated in the SSB, RO location, TA, receive beam, value related to power adjustment related to PRACH transmission, or the number of successful random access using the SSB, or the like.

If it is determined in operation 1902 that the corresponding relationship between SSB index and beam will change, then perform:

Operation 1907: CPE resets or zeroes or initializes the corresponding relationship table;

Operation 1908: CPE re-receives SSB beam and transmits msg1 based on the information carried by the new SSB;

Operation 1909: CPE obtains the receive beam based on a beam management process;

Operation 1910: CPE records cell ID, SSB index, and corresponding receive beam and frequency information;

Then proceed to operation 1906: update the table.

If it is determined in operation 1903 that the SSB index is not included in the list, or it is determined in operation 1905 that the RAR has not been successfully received, perform operations 1908, 1909, 1910 and 1906.

According to the flow chart shown in FIG. 19, CPE performs SSB reception and measurement, selects a beam pair used for random access, obtains the SSB-related information carried therein, and determines whether the corresponding relationship between the transmit beam and SSB index at the base station will change based on the result of comparison between the measured reference signal power value and a specific threshold. If the corresponding relationship will change, the corresponding relationship table for beam maintained by CPE is zeroed, CPE uses the beam used in SSB reception and measurement for random access, and after successful access, it performs beam management to obtain a high-gain beam pair for communication, and records the corresponding information in the stored file. If the corresponding relationship will not change, CPE retrieves the stored file to determines whether the SSB index corresponding to the cell ID is included in the stored file. If the SSB index corresponding to the cell ID is included in the stored file, CPE uses the receive beam corresponding to the stored file to perform random access. After successful access, in the beam management process, only different narrow transmit beams of base stations need to be measured and reported to obtain the high-gain beam pair for communication. If the SSB index corresponding to the cell ID is not included in the stored file, CPE uses the beam used for SSB reception and measurement for random access, and performs sweeping of transmit and/or receive beams after successful access to obtain the high-gain beam pair for communication, and records the corresponding information in the stored file.

### Example 2

The uplink signal transmission power value determined by the terminal for transmitting the random access preamble can be calculated by the following Equation 1-1. Where P_{CMAX} is the maximum power value for transmission of the terminal, which is related to the terminal type, P_{PRACH,target,f,c} is the target received power, which is configured by the high layer, PL_{b,f,c} is the path loss compensation value.

$${P}_{PRACH , b , f , c} ( i ) = min \{ {P}_{CMAX , f , c} ( i ) , {P}_{PRACH , target , f , c} + {PL}_{b , f , c} \} [ dBm ] \qquad Equation 1 ‐ 1$$

The path loss compensation value PL_{b,f,c} is the difference between the downlink reference signal power transmission value at the base station and the reference signal reception power value measured by the terminal, as shown in the following Equation 1-2, where the reference signal transmission power referenceSignalPower can be determined according to the information in SSB, and the HigherlayerfilteredRSRP refers to the reference signal power value within the specified bandwidth measured by the terminal.

$$P L = referenceSignalPower - HigherLayerFilterdRSRP \qquad Equation 1 ‐ 2$$

The value of P_{PRACH,target,f,c} is related to the target received power, the format of preamble and the adjustment value of open-loop power control, which can be calculated by the following Equation 1-3.

$${P}_{PRACH , target , f , c} = preambleReceivedTargetPower + DELTA\_PREAMBLE + ( PREAMBLE\_POWER \_RAMPING \_COUNTER - 1 ) * PREAMBLE\_POWER \_RAMPING \_STEP \qquad Equation 1 ‐ 3$$

Thereinto, the preambleReceivedTargetPower is configured by other nodes (such as base stations), such as through an RRC parameter transmitted by the base stations, DELTA_PREAMBLE can be obtained by retrieve a mapping table according to preamble format.

The terminal adjusts the transmission power value used when transmitting the preamble signal through open-loop power control in random access procedure. At the beginning of random access, the terminal sends a preamble (msg1) according to the power calculated by Equation 1-3 and tries to receive the random access response information (msg2) sent by the base station. If the random access response information from the base station is not received within a certain time T4, the terminal needs to increase the transmission power to resend the preamble and try to receive the random access response information sent by the base station. The power difference between two adjacent transmissions is PREAMBLE_POWER_RAMPING_STEP (hereinafter referred to as step), which can be configured by other nodes (for example, through RRC) and remains unchanged in a random access procedure. If the terminal still does not receive the random access response information from the base station within a certain time T4 after increasing the transmission power, the terminal needs to continue increasing the transmission power of the preamble, with the power value increased by the step every time, until the maximum transmission power value of the terminal or the maximum number of retransmissions (preambleTransMax, this parameter can be configured by nodes, such as RRC) is reached. The value used to count the number of times that the terminal increases the transmission power is PREAMBLE_POWER_RAMPING_COUNTER (hereinafter referred to as counter), and its value is reset to 1 every time the initialization of random access is performed.

In the disclosure, when the type of terminal node connected with the base station is CPE, because the transmission path and environment between CPE and the base station have little change, CPE can adjust the transmission power when sending the preamble for random access request according to the transmission power value when successfully connecting with the base station previously. The method for adjusting the transmission power can be as follows: dynamically adjusting the power adjustment value (step) for the transmission of preamble signal during a random process, configuring a plurality of steps and selecting the transmission power value to increase at each power adjustment according to specific conditions, or adjusting the initial power value of the transmission of preamble signal during random access procedure.

Optionally, when the base station determines that the terminal type is CPE, CPE can be configured by the base station with different uplink transmission power ramping step values (or referred to as power ramping step, PREAMBLE_POWER_RAMPING_STEP, hereinafter referred to as step) for msg1 to shorten the time for CPE to receive the random access response message msg2, and the values can be at least one. For example, at the initialization of initial access, CPE takes the value of the counter from 1, and receives two different power increase values of step1 and step2 configured by the base station (assuming that step1>step2). If the response information from the base station is not received within a certain period of time, CPE increases the transmission power, and the step value of increased transmission power is the larger one, step1 (for example, 4 dB). Before reaching the transmission power value of the previous connection, CPE makes several rounds of attempts with this power adjustment step. When the transmission power is greater than the power of previous connection, CPE tries to connect with the base station with step2 (for example, 2 dB) with a smaller power increase, until it receives the response information from the base station or the transmission power reaches the maximum transmission power of CPE, and CPE records and updates the power information in connection to the corresponding list. Thereinto, the list stores information related to the previous successful random access of CPE, including, for example, the corresponding relationship between the SSB index and the values related to the transmission power adjustment of PRACH. For example, some examples of this list are shown in Table 4-Table 6 mentioned below. The flowchart of the embodiment is shown in FIG. 20.

Referring to FIG. 20, according to the method of the embodiment of the disclosure, random access procedure between CPE and the base station includes at least some of the following operations 2001-2010:

Operation 2001: CPE obtains cell ID and SSB index;

Operation 2002: CPE determines whether the cell ID and/or SSB index are included in the list;

If it is determined in operation 2002 that the cell ID and/or SSB index are included in the list, then perform operation 2003: CPE determines whether the transmission power value P_{PRACH,b,f,c} of the uplink signal (or called PRACH) transmitting the random access preamble is less than the value in list, wherein the value in list can be the PRACH transmission power value in the previous successful random access corresponding to the SSB index or the PRACH transmission power value in the previous successful random access obtained according to the value related to power adjustment corresponding to the SSB index.

If it is determined in operation 2003 that P_{PRACH,b,f,c} is less than the value in list, then perform operation 2004: CPE determines the PRACH transmission power according to the power ramping step of Step=8 dB;

In operation 2005, CPE determines whether the random access is successful;

If it is determined in operation 2005 that the random access is successful, in operation 2006, CPE records the relevant information in this random access and updates the list, wherein the recorded information is, for example, but not limited to, at least some of the following: SSB index, information carried or indicated in SSB, resource location of RO, timing advance TA value, receive beam, values related to PRACH transmission power (for example, power adjustment value for PRACH transmission power, PRACH). By updating the list, the number of times of successful random access corresponding to the SSB index related to this random access and/or the information related to transmission power may be updated.

If it is determined in operation 2003 that P_{PRACH,b,f,c} is not less than the value in list, then perform operation 2007: CPE determines the PRACH transmission power according to the power ramping step of Step=2 dB, and then proceeds to operation 2005.

If it is determined in operation 2005 that the random access is not successful, proceed to operation 2010: CPE increases the value of the power ramping counter by 1, and then proceed to operation 2003.

If it is determined in operation 2002 that the cell ID and/or SSB index are not included in the list, proceed to operation 2008: CPE sets the value of counter to 1, and the power ramping step to 2 dB, to determine the PRACH transmission power and performs random access. After that, CPE determines whether the random access is successful (not shown in the figure). If the random access is successful, performs operations 2009 and 2006: CPE records the cell ID and/or SSB index, and the corresponding rx beam, counter value, or frequency information, and records and updates the list, wherein the frequency information indicates the number of times of successful random access, which can be obtained by, for example, updating the previously recorded number of times of success based on the current successful random access.

By using this method, when the transmission power of CPE is less than the power value of previous connection, by trying to connect with the base station from small transmission power, the problem of long connection time caused by multiple times of increasing power can be weakened, and the interference to other terminals caused by direct use of high-power connection can be avoided, using the method of high power ramping step can reduce the time for multiple rounds of power increase and waiting for random access response information, when the transmission power of CPE is greater than the power value of the previous connection, if CPE still fails to receive the random access response information from the base station, CPE adopts a small power ramping step, which can avoid the interference to other terminals and the increase of power consumption of CPE caused by excessive transmission power.

Optionally, as shown in the following Equation 1-4, in calculating the power value for transmitting the random access preamble, based on the original Equation 1-3, CPE can add P_b, the value of which is related to the corresponding increased value of the transmission power of the preamble when CPE connects to the base station through transmit and receive beam pair corresponding to SSB index previously, where P_b is the adjusted value of multiple power increases previously. For example, P_b=(counter-1)*step, where counter is the value of the power ramping counter corresponding to the preamble transmission power for the previous successful random access of UE, and step is the power ramping step corresponding to the preamble transmission power for the previous successful random access of UE.

$${P}_{PRACH , target , f , c} = preambleReceivedTargetPower + DELTA\_PREAMBLE + P\_b + ( PREAMBLE\_POWER \_RAMPING \_COUNTER - 1 ) * PREAMBLE\_POWER \_RAMPING \_STEP \qquad Equation 1 ‐ 4$$

According to Equation 1-4, when UE makes the first random access attempt in random access procedure, it can start from the preamble transmission power in the previous successful random access, thus reducing the number of attempts.

In some embodiments of the disclosure, in order to reduce the space occupied by storing the power adjustment value P_b, when CPE calculates the transmission power of preamble in initiating the random access procedure, the value of the counter related to its transmission power adjustment does not need to be reset to 1 in the initialization process of random access, and its value can be set according to the data for successful connection with the base station previously. For example, CPE can send the preamble with the previous transmission power of msg1 for which random access response information from the base station has received, and try to receive the random access response information from the base station. This method can reduce the waiting time and signaling overhead of repeatedly increasing the transmission power to try to receive the random access response information from the base station, and accelerate the speed of establishing a connection with the base station. If the response information of the base station is not received within a certain time, increase the transmission power and add 1 to the value of the counter.

Optionally, when determining the power value for sending the random access preamble signal, CPE can refer to the power value when successfully connecting with the same base station through the same beam pair previously. For example, CPE can store and manage information, such as SSB index, cell ID of base station identity information, and transmission power of preamble when CPE successfully receives random access response information from base station, or the like, for every success connection of random access. When CPE performs SSB reception and measurement and obtains the information (for example, SSB index, cell ID) carried in the SSB from the selected SSB beam, it can then judge whether the beam corresponding to the SSB is the one connected previously by retrieving the stored file. If this beam is a previously connected beam, CPE can retrieve in the stored file and determine the uplink transmission power information when random access response information from the base station is successfully received by using this beam pair, and CPE can directly use this power to transmit the preamble. The stored file can be in the form of a table, as shown in Table 4 below, which records different cell ID and SSB index, and the corresponding uplink preamble transmission power value of CPE when the random access response information from the base station is successfully received.

TABLE 4

| Cell ID | SSB index | Transmit power value |
|---|---|---|
| X1 | Y1 | P_b1 |
| | Y2 | P_b2 |
| X2 | Y3 | P_b3 |

Optionally, transmission path loss may change due to different transmission environments, and such dynamic adjustment of part of power can be realized by the calculated different path loss compensation values PL_{b,f,c}, so the reference power value recorded by CPE can be in the form of the counter value (denoted as M) for calculating the corresponding uplink transmission power when the random access response information from the base station is successfully received, as shown in Table 5 below.

TABLE 5

| Cell ID | SSB index | Counter value M |
|---|---|---|
| X1 | Y1 | M1 |
| | Y2 | M2 |
| X2 | Y3 | M3 |

Optionally, when CPE retrieves the stored file based on the information carried in the obtained SSB, if the SSB has no data related to previous connection, that is, the counter value used for its previous connection cannot be retrieved in the table, the counter value for calculation of power value when CPE sends the preamble is initialized to 1. After successfully receiving the random access response information from the base station, the used SSB index, the identity information of the base station cell ID, and the counter value corresponding to the transmission power of the preamble when the CPE successfully receives the response information from the base station are recorded in the storage unit for management for later power value calculation.

Optionally, CPE can record the number of times of using different counter values corresponding to the uplink power of transmission by CPE in the data record file of the storage unit after each successful reception of the random access response information from the base station. When CPE determines the uplink transmission power of the random access preamble by retrieving the table, the counter value for calculating transmission power corresponding to the most number of times of successful connection among the counter values corresponding to the cell ID and SSB index is selected with priority, as shown in Table 6 below.

TABLE 6

| Cell ID | SSB index | Counter value M | Number of times |
|---|---|---|---|
| X1 | Y1 | M1 | N1 |
| | | M2 | N2 |
| | Y2 | M3 | N3 |
| X2 | Y3 | M4 | N4 |
| | | M5 | N5 |

The increase of transmission power of msg1 by the terminal in random access procedure can compensate for the inaccuracy of path loss calculation, or increase the probability of the terminal accessing the base station successfully. Therefore, if CPE directly uses the counter value M used in the previous connection, it may lead to an increase in the power consumption of the terminal, and in some cases, it will also cause interference to other terminals. Therefore, for the transmission power value of msg1 in the random access of CPE, it can be calculated by referring to the relevant value of the counter value M or a value less than M when the same beam as previous is used for connection, for example, M-1, floor(M/2) (rounding down of M/2). The transmission power adjustment of msg1 calculated based on this counter value can reduce the waiting time for CPE to repeatedly ramping power and try to receive the random access response information from the base station, shorten the time for CPE to access the base station, and also avoid the increase of power consumption and/or interference to other terminals caused by excessive transmission power.

CPE can choose whether to use M or other value related to M (for example, M-1) when calculating the transmission power value of msg1 for random access, by comparing the measured value of transmission path loss with a specified threshold, the threshold for comparison is related to the reference value of path loss when CPE is connected to the base station through the selected SSB (for example, the average value of multiple path loss measurement results, or the path loss value measured under specified condition, or the numeral value obtained by calculating the path loss measurement value). For example, the relationship between the threshold and the path loss reference value can be: threshold=path loss reference value −b*step, or threshold=c* path loss reference value. When the transmission path loss measured by CPE is less than the threshold, the transmission path loss is small, so a smaller transmission power can be used, for example, M-1 is used in the calculation of transmission power value. When the transmission path loss measured by CPE is greater than the threshold, the transmission path loss is larger, and larger transmission power can be used, for example, M+1 is used in the calculation of transmission power value. The calculation relationship between the threshold and the reference value of the path loss and the associated calculation coefficients (b, c) can be stored in CPE in advance or notified by other nodes.

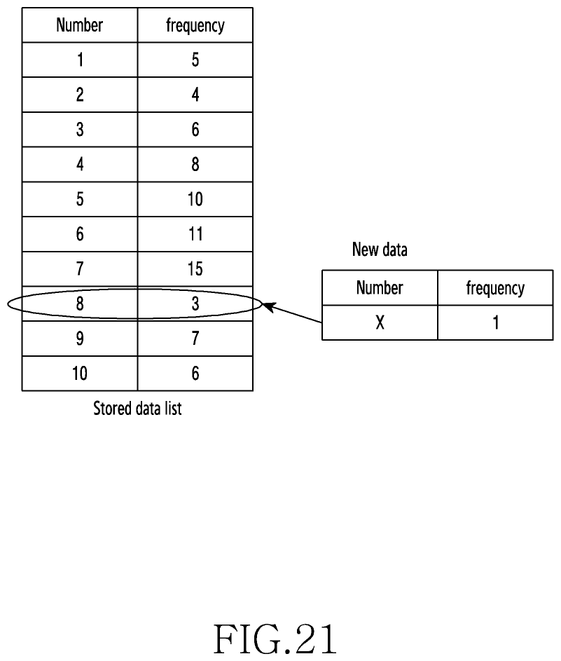

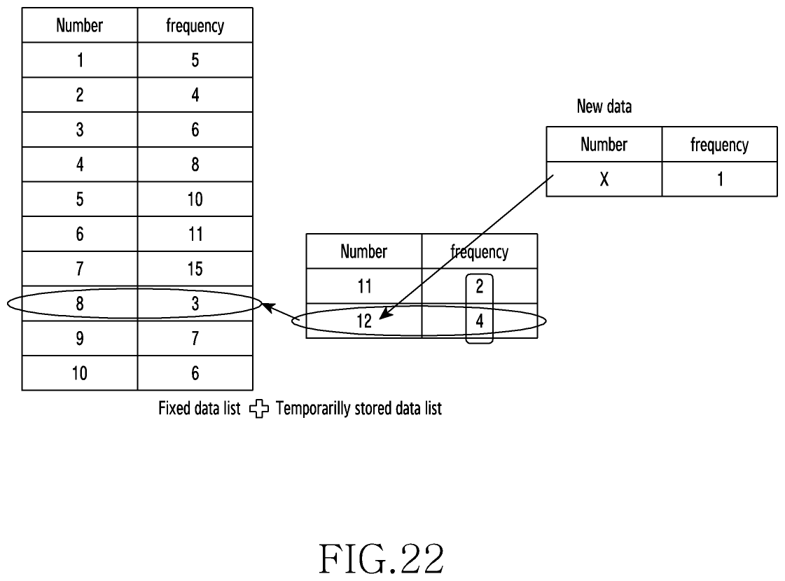

FIGS. 21 and 22 illustrate schematic diagrams of CPE storing SSB-related data according to various embodiments of the disclosure.

Referring to FIGS. 21 and 22, optionally, because the change in location of CPE relative to the base station is small, the number of beams for connection is limited, and the number of counter values corresponding to CPE transmission power value adjustment is limited, so the amount of information stored can be limited in order to reduce the space occupied by storing the value corresponding relationship file. Thereinto, the limited number can be at least one of: the total number of stored cell IDs, the total number of stored SSBs (distinguishing different cell IDs), the number of SSBs corresponding to a single cell ID, the total number of counter values (distinguishing different cell IDs and different SSBs), and the total storage space and memory. For example, the number of SSBs commonly used for storage and management can be limited to ten. When new SSB data need to be stored, the corresponding SSB data with the least total usage (including different power counter values) will be directly overwritten with the new SSB data. For example, as shown in the embodiment of FIG. 21, the total number of SSBs commonly used for CPE storage and management is limited to ten. When new SSB data needs to be stored, the SSB corresponding data with the least total usage (including different receive beams) is directly overwritten with the data corresponding to the new SSB. In the embodiment of FIG. 21, SSB numbered X overwrites the data numbered 8 with the lowest frequency in the original stored list.

In some cases, the new SSB may be a beam that has been reflected many times, with a lower frequency of usage than the overwritten SSB. Therefore, a temporary stored list of new SSB data can be designed. If there is new SSB related data, it will not directly overwrite the original SSB data, but it will be stored in the temporary stored list for continuous recording, and the original SSB with the least usage will be overwritten under certain condition. The condition can be: the number of times the SSB is used within a certain period of time, or there is new SSB data to be recorded. The time period can be configured by other nodes or stored in CPE in advance, and the threshold for comparison with the number of times can be a specific value configured by other nodes or stored in CPE in advance, or the total number of times the original SSB is used. In this embodiment of the disclosure, the list to be maintained by CPE includes a fixed data list and a temporary data list, with the maximum number of storage for the fixed data list being 10 and the maximum number of storage for the temporary data list being 2, as shown in FIG. 22. If there is new SSB data to be recorded (numbered X) and the temporary data list is full, it is necessary to update the data with the highest frequency (numbered 12) in the temporary data list to the fixed data list, overwriting the original data with the least frequency (numbered 8), and record the new data in the temporary data list, and continuously record the information related to frequency of its usage.

If the relationship between SSB and beam of the base station will change, such as the coverage of the base station is adjusted, the transmission direction of the beam corresponding to the same SSB will change, and the transmission path loss of the same SSB connected to the same CPE will change greatly, so the reference significance of the data in the data list maintained by CPE to the actual transmission environment weakens, and the success probability of access by continuing using the power value calculated from the retrieved data. Therefore, before CPE calls the stored data, such as transmission power for use with priority, it is necessary to determine whether the data list is valid. This determination can be informed by other nodes (for example, the base station sends indication information to inform CPE that the corresponding relationship between SSB and beam direction at the base station will change), or it can be determined by CPE based on the tested data. Thereinto, the judgment based on the test data can be realized by monitoring the change in transmission loss of the transmission path from the base station to the CPE. If the change in loss of the transmission path exceeds a specific threshold (for example, x % of the transmission path loss), it is determined that the corresponding relationship at the base station SSB will change, and the threshold can be configured by other nodes or stored in the storage space of the CPE node in advance. The calculation of transmission path loss can be obtained by calculating the difference between the received power value of designated signal and the transmission power value, wherein the transmission power value can be informed by the transmitting node (e.g., the base station). If the power value of designated signal sent by the base station is a fixed value, the monitoring value that CPE judges whether the SSB corresponding relationship at the base station will change can be directly changed into the received power value of the designated signal, the transmission power value is directly stored in the CPE node without additional signaling, thus reducing the signaling overhead.

If the threshold for judging whether the transmission path will change is the long-term statistical value (e.g., average value) of the transmission loss when transmitting with the path, the data of identification information of transmission path (e.g., cell ID, SSB index, counter value) and measurement value of transmission loss can be maintained at CPE, and this data can be updated every time the beam is used to access the base station. The statistical form of the data can be a table, as shown in Table 7 below. The calculation of the statistical value for each update can be the average of the value in list P0 and the new test result Pi, or the weighted average (for example, a*P1+(1−a)*Pi). The calculation method of the statistical value and the weighting coefficient a can be obtained from other nodes or stored in the storage structure of CPE in advance.

TABLE 7

| Cell ID | SSB index | Counter value | Threshold power |
|---|---|---|---|
| X1 | Y1 | M1 | P1 |
| | | M2 | P2 |
| | Y2 | M3 | P3 |
| X2 | Y3 | M4 | P4 |
| | | M5 | P5 |

If part of the content of the variables for distinguishing different beam for use by CPE and for judging whether the corresponding relationship between beam direction and SSB will change by CPE are the same, for example, in this embodiment of the disclosure, both including cell ID and SSB index. In order to reduce the memory for storing the threshold information, the statistical table of the receive beams and the statistical table of the threshold power can be updated and maintained together, as shown in Table 8 below.

TABLE 8

| | SSB | Counter | Threshold | Number |
|---|---|---|---|---|
| Cell ID | index | value | power | of times |
| X1 | Y1 | M1 | P1 | N1 |
| | | M2 | | N2 |
| | Y2 | M3 | P2 | N3 |
| X2 | Y3 | M4 | P3 | N4 |
| | | M5 | | N5 |

If the CPE is a newly established network node with no previous connection data with other nodes, or if the CPE is not a newly established network node, but the corresponding relationship between SSB and the actual output beam will change, the data information stored previously is invalid. To determine the transmission power for the connection between the CPE and the base station, it is necessary to follow the method shown in Equation 1-1 and try to connect with the base station from small power based on the same power ramping step, and record the result of connection and update the same in the statistical list.

### Embodiment 2-3

In some embodiments of the disclosure, CPE can refer to the information (SSB-related information and uplink transmission power value) when it successfully connects with the base station previously as well, to simplify the process of receiving SSB and obtaining the related information carried and indicated in it, to reduce the number of attempts to receive the random access response information from the base station with different transmission powers in the process of connecting with the base station, to shorten time for the connection with the base station and to reduce the signaling overhead.

In some embodiments of the disclosure, when there is a new connection requirement, the beam pair previously used by CPE may still meet the transmission conditions, so CPE can initiate a random access request to the base station directly based on the previous SSB-related information (including at least one of: RO related time-frequency resources, SSB index, cell ID, and uplink transmission power), after completing downlink timing synchronization by measurement of SSB, without reading all the information in SSB. CPE measures SSB with the beam used previously for downlink synchronization, and directly sends the preamble (msg1) of random access request on the RO time-frequency resources associated with previous SSB, with the same beam direction and transmission power value as previously. The base station receives msg1 sent by CPE, and determines the beam used to send msg2 according to the RO location information. If the same user requests access using the same RO resource, the base station can identify the user using the RO resource through subsequent msg3 and msg4, or the base station can identify the terminal type as CPE based on specific information and allocate the RO resource to CPE with priority. Thereinto, this specific information can be terminal type indication information sent by CPE, or dedicated resource information used by CPE (for example, CPE-specific RO, CPE-specific preamble). If the random access response information from the base station is not received within a certain period of time, CPE can increase the transmission power based on the current uplink transmission power for preamble signal, and try to receive the random access response information sent by the base station until the maximum transmission power or the maximum number of retransmissions of CPE is reached. In this process, CPE only measures the received SSB to obtain downlink synchronization related information, without reading other information contained and indicated in SSB, which greatly shortens the time for connection with the base station and reduces the signaling overhead. At the same time, the transmission power used when the previous connection was successful can be referred by the CPE for the transmission power value, which reduces the waiting time and signaling overhead in repeatedly ramping the transmission power to try to receive the random access response information from the base station and speeds up the connection with the base station.

Optionally, a higher data transmission rate can be obtained by using the beam pair with the maximum transmission gain between CPE and base station communication, and the beam pair with the maximum transmission gain may change with the change of transmission environment. In the process of SSB measurement and selection for SSB reception and measurement by CPE, the transmit beam at base station corresponding to the SSB that first meets the transmission condition may not be the beam with the maximum transmission gain, so CPE can be configured with the priority of SSB selection to improve the probability of finding high-gain beam pair and improve the information transmission rate. For example, CPE can be configured to give priority to the SSB used in the previous connection, that is, in the process of SSB measurement and selection, when the CPE receives the SSB meeting the transmission condition (such as RSRP>threshold power) within a certain time T1, it reads the identity-related information (such as SSB index and cell ID) of the SSB and makes a judgment. Thereinto, the related information for setting SSB selection priority can be sent by other nodes (such as base stations) or stored in CPE in advance. If the measured SSB meeting the transmission condition is the same as the identity information of an SSB used previously, CPE completes downlink synchronization based on information in the SSB, determines the transmission power of the random access preamble with reference to the previous information based on the previous connection information, and attempts to receive the random access response information from the base station. If the measured SSB that meets the transmission condition is different from the identity information of SSB used previously, CPE will not directly use the information carried in the SSB to connect with the base station, but will continue to receive and measure SSB until it finds an SSB that meets the transmission condition and is the same as the identity information of SSB used previously. If the beam with the same identity information as the SSB used previously is not measured within T1, or the beam is measured but does not meet the transmission condition (for example, RSRP<threshold power), CPE can select other SSB-related beam that meets the transmission condition as the beam for connection. For example, the first SSB that meets the transmission condition measured by CPE within the time period T2 after T1 (for example, T2 is less than or equal to T1), based on the information carried and indicated by the SSB and the previous connection information, determines the transmission power of the random access preamble with reference to the previous information, and attempts to receive the random access response information from the base station.

Optionally, if the CPE does not receive the random response information msg2 sent by the base station within a certain time T3 after sending msg1 using the previous SSB-related information, the CPE can re-detect the SSB and initiate a random access procedure based on the information carried and indicated by the SSB that meets the transmission condition. Wherein, the time T3 may be the time in which the CPE increases the power for many times to send msg1 and tries to receive the random access response information from the base station, and/or the time in which the CPE tries to receive the random access response information sent by the base station using multiple beams. Or, CPE receives the random access response information sent by the base station, but fails to connect to the base station in the subsequent contention process, CPE can re-detect SSB and initiate random access procedure based on the information carried and indicated by SSB that meets the transmission condition.

If the corresponding relationship between the SSB identity information and the actual beam at the base station will change, for example, the transmission environment around the base station will change, the transmission direction of the beam corresponding to the same SSB index in the same cell will change, the transmission path for connection between the beam with the same SSB identity information obtained by CPE in the SSB receiving and measuring process and the CPE will change greatly. At this time, the reference significance of the previous connection of CPE to the actual transmission path is weakened, and the success probability of continuing to use the previous information for random access procedure is reduced. If continue to use relevant parameters to try random access, it will introduce additional time and signaling overhead. Therefore, it is necessary to determine whether the corresponding relationship between the SSB index and the actual beam at the base station will change, that is, whether the existing transmission path is consistent with the transmission path when recording the data in the data list, before the random access of the SSB-related information used by CPE.

Optionally, whether the corresponding relationship between the SSB index and the actual beam will change can be notified to CPE by other nodes, for example, the base station sends indication information to inform CPE that the corresponding relationship between the SSB index and the actual beam will change, and the indication information can be stored in SSB. This indication information can be stored in SIB1. CPE needs to parse MIB information carried in SSB, and parse corresponding SIB information based on the indication information in MIB, so as to obtain the indication information of whether the SSB index corresponding relationship will change. Alternatively, the indication information can be stored in MIB, and CPE only needs to analyze the MIB information carried in SSB to obtain the indication information of whether the corresponding relationship of SSB index will change. The indication information may be in the form of 2 bits, which defines the time point when the corresponding relationship between SSB index and beam will change in a long time period. Based on such time information, CPE determines whether the previous connection information stored by CPE is consistent with the corresponding relationship for SSB received this time.

Optionally, whether the corresponding relationship between the SSB index and the actual beam will change can be judged by CPE based on specific test data, according to specific rule. For example, the judgment based on test data can be realized by monitoring the measured transmission loss value of the transmission path from the base station to the CPE. If the change amount of the transmission path loss exceeds a specific threshold (for example, x % of the previous transmission path loss measurement value, which can be configured by other nodes or stored in the CPE in advance), it is determined that the corresponding relationship between the beam of the base station and the SSB index will change, and the threshold can be configured by other nodes (such as through RRC) or stored in the CPE node in advance. The calculation of transmission path loss can be obtained by calculating the difference between the power value of designated signal received by CPE and the transmission power value, where the transmission power value can be informed by the transmitting node (e.g. base station). If the power value of designated signal sent by the base station is a fixed value, the monitoring value that CPE judges whether the SSB corresponding relationship of the base station will change can be the received power value of designated signal, and the transmit power value is directly stored in the CPE node without additional signaling, so as to reduce the signaling overhead.

Optionally, if the threshold for determining whether the transmission path will change is related to the long-term statistical value (e.g., average value) of the transmission loss during transmission of the path, for example, the threshold is x % of the long-term statistical value of the transmission loss, the data of the identification information (e.g., cell ID and SSB index) of the transmission path and the statistical value of the transmission loss can be maintained at CPE, and the statistical value can be updated every time the same transmission path (i.e., the same cell ID and SSB index) is used to access the base station. The statistical form of the data may be in the form of table, as shown in Table 9 below. Thereinto, the calculation of statistical value of each update is related to the previous statistical value P1 (the value in the statistical table) and the current measured value Pi, for example, it can be the weighted average of the statistical value P0 and the current measured value Pi (a*Pi+(1−a)*P1). The calculation method of the statistical value can be obtained from other nodes (weighting factor a) or stored in the storage structure of CPE in advance.

TABLE 9

| Cell ID | SSB index | Statistical power value |
|---|---|---|
| X1 | Y1 | P1 |
| | Y2 | P2 |
| X2 | Y3 | P3 |

Optionally, when determining the power value for transmitting the random access preamble signal, CPE can refer to the power value when successfully connecting with the same base station through the same beam pair previously. For example, CPE can store and manage information, such as SSB index, cell ID of base station identity information, and transmission power of preamble when CPE successfully receives random access response information from base station. When CPE performs SSB reception and measurement and obtains the information (for example, SSB index, cell ID) carried in the SSB from the selected SSB beam, it can then judge whether the beam corresponding to the SSB is the one connected previously by retrieving the stored file. If the previous connection information related to the SSB is not found in the stored file, CPE needs to calculate the transmission power value according to the initial access configuration information (counter=1) of the base station and transmit a random access request. If the SSB is a previously connected beam, that is, the corresponding CPE beam information and/or uplink transmission power information can be retrieved and determined in the stored file, and the CPE can directly use the power to transmit the preamble, thus improving the probability of receiving the random access signal and shortening the time for accessing the base station. Thereinto, the form of the stored uplink transmission power of CPE can be the actually used transmission power value or the counter value for ramping the uplink power. The stored file can be in the form of a table, as shown in Table 10 below.

TABLE 10

| Cell ID | SSB index | Counter Value |
|---|---|---|
| X1 | Y1 | M1 |
| | Y2 | M2 |
| X2 | Y3 | M3 |

Optionally, CPE can record the number of times that different transmission power values are used when successfully connecting with the base station in the data record file. When CPE determines the used transmission power in the retrieve table, it gives priority to using the counter with the most number of times of successful connection corresponding to the cell ID and SSB index, as shown in Table 11 below.

TABLE 11

| Cell ID | SSB index | Counter value | Number of times |
|---|---|---|---|
| X1 | Y1 | M1 | N1 |
| | | M2 | N2 |
| | Y2 | M3 | N3 |
| X2 | Y3 | M4 | N4 |
| | | M5 | N5 |

Optionally, if part of the variables for distinguishing the uplink transmission power of beams associated with different SSBs connected by CPE and for distinguishing whether the corresponding relationship between beam direction and SSB will change judged by CPE are the same, for example, in this embodiment of the disclosure, both including cell ID and SSB index, in order to reduce the storage space for storing the uplink power value of the threshold information, the statistical table of receive beams and the statistical table of threshold power can be updated and maintained together, as shown in Table 12 below.

TABLE 12

| Cell ID | SSB index | Counter value | Threshold powers |
|---|---|---|---|
| X1 | Y1 | M1 | P1 |
| | | M2 | P2 |
| | Y2 | M3 | P3 |
| X2 | Y3 | M4 | P4 |
| | | M5 | P5 |

The increase of transmission power of msg1 by the terminal in random access procedure can compensate for the inaccuracy of path loss calculation, or increase the success probability of the terminal accessing the base station. Therefore, if CPE directly uses the counter value M used in the previous connection, it may lead to an increase in the power consumption of the terminal, and in some cases, it will also cause interference to other terminals. Therefore, for the transmission power value of the random access msg1 of CPE, a relevant value of the counter value M when the same beam is used for connection previously or a value less than M can be referred to, for example, M-1, floor(M/2) (rounding down of M/2). The transmission power adjustment of msg1 calculated based on this counter value can reduce the waiting time for CPE to repeatedly ramp power and try to receive the random access response information from the base station, shorten the time for CPE to access the base station, and also avoid the increase of power consumption and/or interference to other terminals caused by excessive transmission power.

CPE can choose whether to use M or other M-related values (for example, M-1) when calculating the transmission power value of msg1 for random access, by comparing the measured value of transmission path loss with a specified threshold, the threshold for comparison is related to the reference value of path loss for connection of CPE to the base station through the selected SSB (for example, the average value of multiple path loss measurement results, or the path loss value measured under specified condition, or the value obtained by calculating the path loss measurement values). For example, the relationship between the threshold and the path loss reference value can be: threshold=path loss reference value −b*step, or threshold=c*path loss reference value. When the transmission path loss measured by CPE is less than the threshold, the transmission path loss is small, so a smaller transmission power can be used, for example, M-1 is used in the calculation of transmission power value. When the transmission path loss measured by CPE is greater than the threshold, the transmission path loss is larger, and the larger transmission power can be used, for example, M+1 is used in the calculation of transmission power value. The calculation relationship between the threshold and the reference value of the path loss and its associated calculation coefficients (b, c) can be stored in CPE in advance or notified by other nodes.

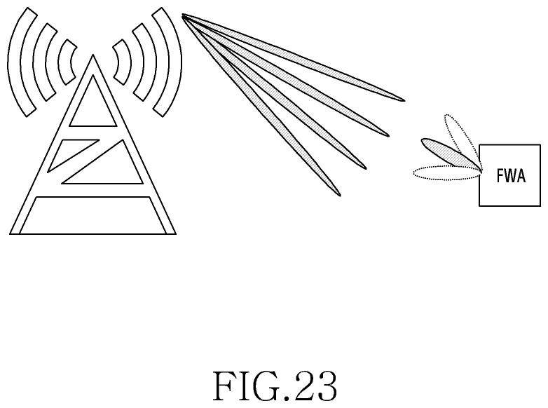

FIG. 23 illustrates a schematic diagram of receiving SSB by CPE using previously used beam according to an embodiment of the disclosure.

Referring to FIG. 23, optionally, in some cases, the transmission environment from the base station to the CPE will change slightly (for example, channel fading will change due to weather changes), and the beam pair used previously may no longer meet the transmission requirements, but the spatial relative location of the base station to the CPE will not change much, and the beam pair used for connection may be a beam pair related to the beams used previously (for example, other beam associated with SSB with a close direction to that of the beam associated with SSB used previously). At this time, CPE can directly use the previously used receive beam for SSB reception without sweep the receive beam, so as to obtain available beam pair and shorten the time of SSB reception process, as shown in FIG. 23. When a CPE receives an SSB that meets the transmission condition (for example, RSRP>threshold power), it can obtain the information carried in the SSB, complete downlink synchronization based on the information indicated by the SSB, initiate random access procedure on the time-frequency resources related to the RO of the SSB, re-establish connection with the base station, to shorten the time required for connection with the base station.

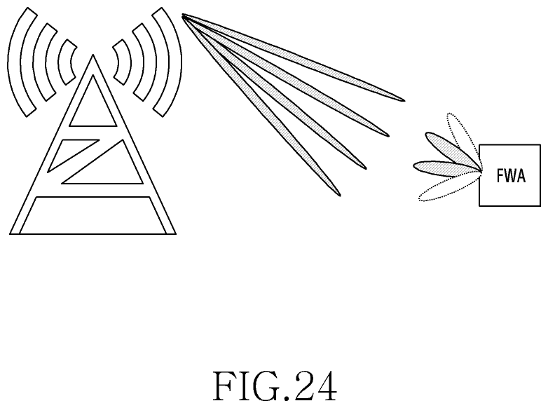

FIG. 24 illustrates a schematic diagram of receiving SSB by CPE using a beam related to previously used beam according to an embodiment of the disclosure.

Referring to FIG. 24, optionally, if SSB reception and measurement are performed by using the receive beam of CPE used previously, and the beam related to SSB meeting the transmission condition cannot be found within a certain time T3, CPE can try to receive the broadcast signal sent by the base station by using a plurality of receive beams in different directions, so as to find an available beam pair for connection with the base station. This time T3 can be the time required for one cycle of SSB (for example, SSB sweep period*number of SSB sweeps), and it can be obtained by at least one of the following methods: configured by other nodes (for example, RRC, base station), pre-stored in the storage unit of CPE, calculated based on the information stored by CPE and/or obtained from other nodes. Thereinto, the beams in different directions can be a beam set covering the service range of CPE, or a plurality of receive beams related to the beam direction used previously. For example, as shown in FIG. 24, CPE uses a plurality of receive beams adjacent to the beam direction used previously, so as to improve the probability of successfully receiving SSB, but it is not necessary to receive SSB in all receive beam directions within the service range of CPE, thus shortening the period of sweeping receive beams and reducing the time required for successfully accessing the base station.

In some embodiments of the disclosure, due to the small coverage of narrow beam in millimeter wave, directly using narrow beam by CPE for SSB reception and measurement may lead to the failure to successfully receive the beam carrying SSB information sent by the base station. In order to improve the probability of successfully receiving SSB during SSB reception and measurement, CPE can use wide beam for SSB reception. If the identity information of SSB transmitting from the base station selected by CPE is the same as that of the SSB used previously (the same SSB index and cell ID), CPE can use the high-gain narrow beam used when disconnecting for transmitting the random access request, so as to shorten the signaling overhead and time of narrow beam selection for CPE in the subsequent beam management process and improve the resource utilization rate.

Optionally, CPE can store and manage the beam information used every time it successfully completes random access with the base station, besides using the beam used previously. When CPE receives and measures SSB and obtains the information carried in SSB, it can judge whether the SSB is a beam connected previously by retrieving the stored file. If the SSB is a beam connected previously (SSB identity information is consistent), CPE can retrieve and determine the beam used when CPE successfully connected previously in the stored file, and CPE can try to directly use this beam for random access procedure. The stored file can be in the form of a table, as shown in Table 13 below. The stored information can include SSB identity information (SSB index), base station identity information (cell ID) and narrow beam information for CPE (receive beam index, or receive beam codebook, or receive beam codebook index).

TABLE 13

| Cell ID | SSB index | RX beam index |
|---|---|---|
| X1 | Y1 | Z1 |
| | Y2 | Z2 |
| X2 | Y3 | Z3 |

Optionally, CPE can record the number of times that the receive beam index has been used when completing random access with the base station successfully in the data record file, and when retrieving the record file to determine the receive beam used by CPE, the receive beam index with the most number of times of successful connection among the receive beam indexes corresponding to the cell ID and SSB index is selected with priority, as shown in Table 3 below. When the cell ID of X1 and SSB index of Y1 is obtained by CPE during SSB reception and measurement, if N1>N2, CPE uses the receive beam with the receive beam index of Z1 to perform random access procedure.

TABLE 3

| Cell ID | SSB index | Receive beam index | Number of times |
|---|---|---|---|
| X1 | Y1 | Z1 | N1 |
| | Y2 | Z2 | N2 |
| X2 | Y3 | Z3 | N3 |

Optionally, when the corresponding relationship between the SSB index and the actual beam at the base station will change, the transmission path for connection of the beam with the same SSB identity information obtained by CPE during SSB reception and measurement and the CPE will change greatly, and the reference significance of the relevant information of previous connection of CPE to the actual transmission path is weakened at this time. Therefore, if it is determined that the corresponding relationship between SSB index and the actual beam at the base station will change before the random access using the SSB-related information previously used by CPE, the table recording the receive beam index used when completing the random access with the base station successfully will be reset to 0.

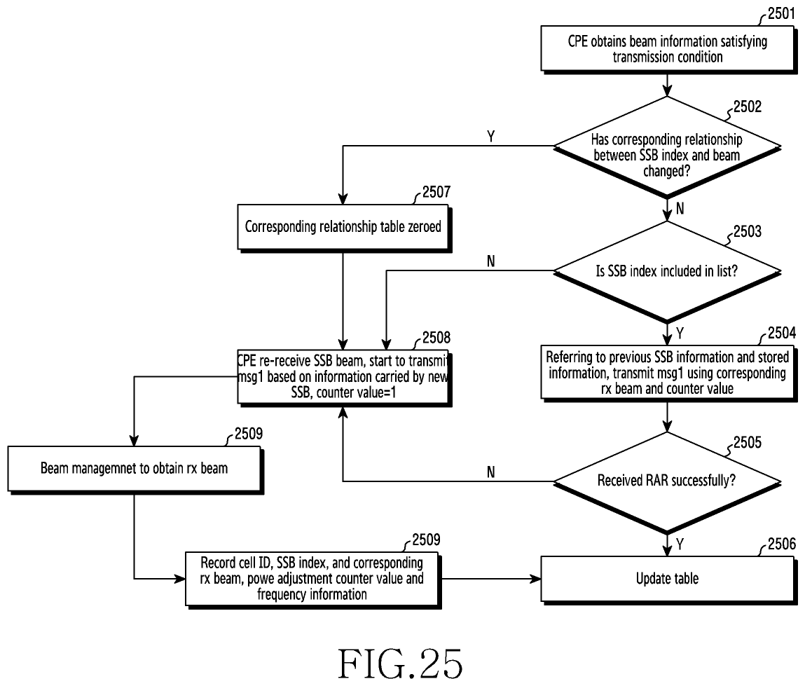

If the CPE is a newly established network node, and there is no previous connection data with the base station as a reference, or if the CPE is not a newly established network node, but the corresponding relationship between SSB index and the actual output beam will change, thus data information stored previously is invalid, and the selection of beam for connection between the CPE and the base station needs to be obtained by sweeping of the transmit and receive beams, respectively. For the narrow beam determined by the selection process of beam management after the successful connection of CPE, it is necessary to determine the transmission power of msg1 for the connection between CPE and the base station by following the method shown in Equation 1-1, starting from small power and based on the same power ramping step, and recording the result of connection and updating the same to the statistical list. The specific flow is shown in FIG. 25.

FIG. 25 illustrates a schematic diagram of a method according to an embodiment of the disclosure.

Referring to FIG. 25, according to the method of the embodiment of the disclosure, random access procedure between CPE and the base station includes at least some of the following operations 2501-2510:
Operation 2501: CPE obtains beam information meeting transmission condition, such as SSB index;
Operation 2502: CPE determines whether the corresponding relationship between SSB index and beam will change;

If it is determined in operation 2502 that the corresponding relationship between SSB index and beam will not change, then perform operation 2503: CPE determines whether the SSB index is included in the list, where the list stores SSB previously used by CPE and some information corresponding to SSB, such as information carried or indicated in SSB, RO location, TA, receive beam, values related to power adjustment related to PRACH transmission, and the number of times of successful random access using the SSB.

If it is determined in operation 2503 that the SSB index is included in the list, then perform operation 2504: CPE refers to the previous SSB information and stored information, to use the corresponding receive beam and calculate the transmission power using the value of the power ramping counter, and transmits msg1, and operation 2505: CPE determines whether random access response (RAR) is successfully received.

If it is determined in operation 2505 that the RAR is successfully received, then performs operation 2506: update the table corresponding to the above list (for example, it can also be called “corresponding relationship table”), for example, the table includes a list of SSB indexes, and each row includes SSB index and information corresponding to the SSB index, including some information during the successful random access procedure performed by CPE based on the SSB previously, for example, information carried or indicated in the SSB, RO location, TA, receive beam, value related to power adjustment related to PRACH transmission, or the number of times of successful random access using the SSB, or the like.

If it is determined in operation 2502 that the corresponding relationship between SSB index and beam will change, then performs:
Operation 2507: CPE resets or zeroes or initializes the corresponding relationship table;
Operation 2508: CPE re-receives the SSB beam, starts to calculate the transmission power based on the information carried by the new SSB and sets the counter value to 1, and sends msg1;
Operation 2509: CPE obtains the receive beam based on a beam management process;
Operation 2510: CPE records cell ID, SSB index, corresponding receive beam, information related to power adjustment (for example, the value of counter) and frequency information;
Then proceed to operation 2506: update the table.

If it is determined in operation 2503 that the SSB index is not included in the list, or it is determined in operation 2505 that the RAR has not been successfully received, operations 2508, 2509, 2510 and 2506 are performed.

CPE receives and measures SSB, selects the beam pair used for random access, obtains the SSB-related information carried therein, and determines whether the corresponding relationship between the transmit beam and SSB index at the base station will change based on the comparison result between the measured reference signal power value and a specific threshold. If the corresponding relationship will change, the beam corresponding relationship table maintained by CPE is zeroed, CPE uses the beam used in SSB reception and measurement for random access, and after successful access, it performs beam management to obtain a high-gain beam pair for communication. To determine the transmission power of msg1 for connection between CPE and the base station, it is necessary to follow the method shown in Equation 1-1 to try to connect with the base station from small power based on the same power ramping step, and record its related information in the stored file. If the corresponding relationship will not change, CPE retrieves the stored file to determines whether the SSB index corresponding to the cell ID is included in the stored file. If the SSB index corresponding to the cell ID is included in the stored file, CPE uses the corresponding receive beam in the stored file to perform random access, and the power value in the stored file can be referred to for the transmission power of the random access preamble signal. After the access is successful, the high-gain beam pair for communication can be obtained only by measuring and reporting the different narrow beams transmitted by base station. If the SSB index corresponding to the cell ID is not included in the stored file, CPE uses the beam used for SSB reception and measurement for random access, and performs sweeping of transmit and/or receive beams after successful access to obtain a high-gain beam pair for communication. To determine the transmission power of msg1 for connection between the CPE and the base station, it is necessary to follow the method shown in Equation 1-1 to try to connect with the base station from small power based on the same power ramping step, and record its related information in the stored file.

Optionally, because the change in location of CPE relative to the base station is small, and the number of beams for connection is limited, in order to reduce the space occupied by storing the beam corresponding relationship file, the amount of information stored can be limited. Thereinto, the limited number can be at least one of: the number of stored cell IDs, the total number of SSBs stored (distinguishing different cell IDs), the number of SSBs corresponding to a single cell ID, the total number of receive beams (distinguishing different cell IDs, different SSBs), the total number of power values (distinguishing different cell IDs, different SSBs, receive beams), and the number of values of power corresponding to a single transmit and receive beam pair, the total memory of storage space. For example, the number of SSBs commonly used for storage and management can be limited to ten. When new SSB data need to be stored, the corresponding SSB data with the least total number of times of usage (including different receive beams) will be directly overwritten with the new data.

In some cases, the new SSB may be a beam that has been reflected many times, with a lower frequency of usage than the overwritten SSB. Therefore, a temporary stored list of new SSB data can be designed. If there is new SSB related data, it will not directly overwrite the original SSB data, but it will be stored in the temporary stored list for continuous recording, and the original SSB with the least number of times of usage will be overwritten under certain condition. The condition can be: the number of times the SSB is used within a certain period of time, or there is new SSB data to be recorded. The time can be configured by other nodes or stored in CPE in advance, and the threshold for comparison with number can be a specific value configured by other nodes or stored in CPE in advance, or the total number of times the original SSB is used. For example, the list that CPE needs to maintain includes a fixed data list and a temporary data list. The maximum number of storage of the fixed data list is 10, and the maximum number of storage of the temporary data list is 2. If there is new SSB data to be recorded (numbered X) and the temporary data list is full, it is necessary to update the data with the highest frequency (numbered 12) in the temporary data list to the fixed data list, overwriting the original data with the least frequency (numbered 8), and record the new data in the temporary data list, and continuously record the frequency-related information of its use.

Optionally, when the base station determines that the terminal type is CPE, the CPE can be configured by the base station with different uplink transmission power ramping step values (or power ramping step, PREAMBLE_POWER_RAMPING_STEP,hereinafter referred to as step) of msg1 to shorten the time for the CPE to receive the random access response message msg2, and the values can be at least one. For example, during the initialization of initial access, CPE still takes the value of the counter from 1, and receives two different power ramping values (step1 and step2) configured by the base station (assuming that step1>step2). If the response information of the base station is not received within a certain period of time, CPE increases the transmission power, and the transmission power step value is increase with a ramp step of the larger step1 (for example, 4 dB). Before reaching the transmission power value of the previous connection, CPE makes several rounds of attempts with this power adjustment ramp step. When the transmission power is greater than the power of previous connection, CPE tries to connect with the base station with a smaller ramp step of step2 (for example, 2 dB), until it receives the response information from the base station or the transmission power reaches the maximum transmission power of CPE, and CPE records and updates the power information during connection to the corresponding list. The flowchart is shown in FIG. 20. By using this method, when the transmission power of CPE is less than the power value of previous connection, by trying to connect with the base station from small transmission power, the problem of long connection time caused by multiple power ramp can be weakened, and the interference to other terminals caused by direct use of high-power connection can be avoided. Using the method of power ramping with large ramp step can reduce the time of multiple rounds of power ramp and waiting for random access response information. When the transmission power of CPE is greater than the power value of the previous connection, if CPE still fails to receive the random access response information from the base station, CPE adopts a small power ramping step, which can avoid the interference to other terminals and the increase of power consumption of CPE caused by excessive transmission power.

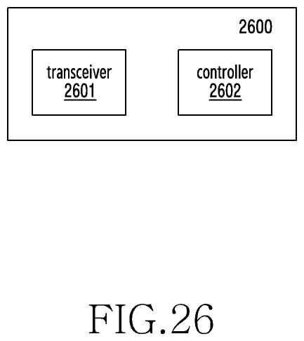

FIG. 26 illustrates a schematic structural diagram of a first device according to an embodiment of the disclosure. The first device may be, for example, a CPE, a FWA-related device, or a user equipment (UE).

Referring to FIG. 26, a first device 2600 includes a transceiver 2601 and a controller 2602. The transceiver 2601 is configured to transmit data or signals and receive data or signals. The controller 2602 is coupled with the transceiver 2601 and configured to perform control so that the first device 2600 performs the method according to the embodiment of the disclosure. In an implementation, the first device 2600 may further include memory (not shown) on which computer-executable instructions are stored. When the instructions are performed by the controller 2602, the first device 2600 may perform at least one method corresponding to the above embodiments of the disclosure.

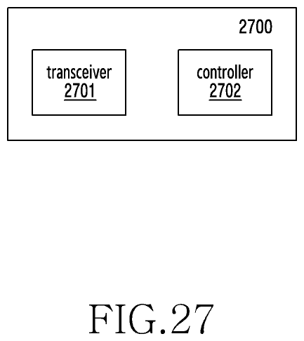

FIG. 27 illustrates a schematic structural diagram of a base station (or a network entity) according to an embodiment of the disclosure.

Referring to FIG. 27, a base station (or the network entity) 2700 includes a transceiver 2701 and a controller 2702. The transceiver 2701 is configured to transmit data or signals and receive data or signals. The controller 2702 is coupled with the transceiver 2701 and configured to perform control so that the base station(or the network entity) 2700 performs the method according to the embodiment of the disclosure. In an implementation, the base station(or the network entity) 2700 may further include memory (not shown) on which computer-executable instructions are stored. When the instructions are performed by the controller 2702, the base station(or the network entity) 2700 may perform at least one method corresponding to the above-mentioned embodiments of the disclosure.

The disclosure relates to a method for random access with a base station. In one aspect, the disclosure provides a method performed by a first device in a communication system. The method includes performing random access procedure, wherein information associated with a first device type is transmitted to a base station during the random access procedure. Transmitting and/or receiving signals based on first resource among scheduled first type resources dedicated to a first device type, wherein the first device type is associated with fixed wireless access technology.

Furthermore, the disclosure also relates to a method performed by a first device and the first device. In one aspect, a method performed by a first device in a communication system includes receiving at least one SSB, determining a first SSB from the at least one SSB based on historical SSB included in historical information, wherein the historical SSB includes the first SSB, determining a transmission power based on second information associated with the first SSB included in the historical information, and transmitting a preamble based on the transmission power, wherein, the second information includes at least one of: a power ramping counter value and a power ramping step size.

The above is only an example embodiment of the disclosure, and it is not used to limit the disclosure. Any modification, equivalent substitution, improvement, or the like, made within the spirit and principle of the disclosure should be included in the scope of protection of the disclosure.

Those skilled in the art will understand that the disclosure includes apparatus for perform one or more of the operations described in this application. These devices can be specially designed and manufactured for required purposes, or they can also include known devices in general-purpose computers. These devices have computer programs stored therein, which are selectively activated or reconfigured. Such a computer program may be stored in a device (e.g., a computer) readable medium including but not limited to any type of disk (including floppy disk, hard disk, optical disk, compact disc read only memory (CD-ROM), and magneto-optical disk), read-only memory (ROM), random access memory (RAM), erasable programmable read-only memory (EPROM), electrically erasable programmable read-only memory (EEPROM), flash memory, magnetic card or optical card. For example, a readable medium includes any medium in which information is stored or transmitted by a device (e.g., a computer) in a readable form.

It will be understood by those skilled in the art that each block in these structural diagrams and/or block diagrams and/or flow diagrams and combinations of blocks in these structural diagrams and/or block diagrams and/or flow diagrams can be implemented by computer program instructions. It can be understood by those skilled in the art that these computer program instructions can be provided to a general-purpose computer, a professional computer or a processor of other programmable data processing methods for implementation, so that the scheme specified in the block or blocks of the structure diagram and/or block diagram and/or flow diagram disclosed in the disclosure can be performed by the processor of the computer or other programmable data processing methods.

Those skilled in the art can understand that the steps, measures and schemes in various operations, methods and processes discussed in the disclosure can be alternated, modified, combined or deleted. Further, other steps, measures and schemes in the various operations, methods and processes already discussed in the disclosure can also be alternated, changed, rearranged, decomposed, combined or deleted. Further, steps, measures and schemes in various operations, methods and flows disclosed in the disclosure in the prior art can also be alternated, changed, rearranged, decomposed, combined or deleted.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
performing a random access procedure with a base station by transmitting, to the base station, first information related to a device type associated with fixed wireless access (FWA) during the random access procedure; and
receiving, from the base station, signals based on a first type resource which is dedicated to the device type associated with the FWA.

2. The method of claim 1, further comprising:
receiving, from the base station, system information including second information on a resource location for random access occasions (ROs) dedicated to the device type,
wherein the performing the random access procedure comprises:
transmitting, to the base station, a preamble on the ROs dedicated to the device type,
wherein the second information includes a first offset of the resource location of the ROs relative to ROs which are not dedicated to the device type, and
wherein the first offset is at least one of a time domain offset or a frequency domain offset.

3. The method of claim 1, further comprising:
receiving, from the base station, at least one of third information on index of ROs dedicated to the device type on ROs of a second type resource or fourth information on index of preambles dedicated to the device type,
wherein a location of the second type resource is different from a location of the first type resource, and
wherein the performing the random access procedure comprises:
transmitting, to the base station, a preamble based on at least one of the ROs dedicated to the device type or the preambles dedicated to the device type.

4. The method of claim 1, wherein the first information is transmitted to the base station through message 3 during the random access procedure.

5. The method of claim 2,
wherein the performing of the random access procedure comprises:
receiving, from the base station, a random access response (RAR) on a common control channel which is the first type resource, and
wherein, a location of the common control channel is identified by fifth information on a second offset relative to the second type resource in the system information.

6. A method performed by a base station in a wireless communication system, the method comprising:
performing a random access procedure with a terminal by receiving, from the terminal, first information related to a device type associated with fixed wireless access (FWA) during the random access procedure; and
transmitting, to the terminal, signals based on a first type resource which is dedicated to the device type associated with the FWA.

7. The method of claim 6, further comprising:
transmitting, to the terminal, system information including second information on a resource location for random access occasions (ROs) dedicated to the device type,
wherein the performing the random access procedure comprises:
receiving, from the terminal, a preamble on the ROs dedicated to the device type,
wherein the second information includes a first offset of the resource location of the ROs relative to ROs which are not dedicated to the device type, and
wherein the first offset is at least one of a time domain offset or a frequency domain offset.

8. The method of claim 6, further comprising:
transmitting, to the terminal, at least one of third information on index of ROs dedicated to the device type on ROs of a second type resource or fourth information on index of preambles dedicated to the device type,
wherein a location of the second type resource is different from a location of the first type resource, and
wherein the performing the random access procedure comprises:
receiving, from the terminal, a preamble based on at least one of the ROs dedicated to the device type or the preambles dedicated to the device type.

9. The method of claim 6, wherein the first information is received from the terminal through message 3 during the random access procedure.

10. The method of claim 7,
wherein the performing of the random access procedure comprises:
transmitting, to the terminal, a random access response (RAR) on a common control channel which is the first type resource, and
wherein, a location of the common control channel is identified by fifth information on a second offset relative to the second type resource in the system information.

11. A terminal in a wireless communication system, comprising:
a transceiver; and
at least one processor coupled with the transceiver, and configured to:
perform a random access procedure with a base station by transmitting, to the base station, first information related to a device type associated with fixed wireless access (FWA) during the random access procedure, and
receive, from the base station, signals based on a first type resource which is dedicated to the device type associated with the FWA.

12. The terminal of claim 11,
wherein the at least one processor is further configured to:
receive, from the base station, system information including second information on a resource location for random access occasions (ROs) dedicated to the device type, and
transmit, to the base station, a preamble on the ROs dedicated to the device type,
wherein the second information includes a first offset of the resource location of the ROs relative to ROs which are not dedicated to the device type, and
wherein the first offset is at least one of a time domain offset or a frequency domain offset.

13. The terminal of claim 11,
wherein the at least one processor is further configured to:
receive, from the base station, at least one of third information on index of ROs dedicated to the device type on ROs of a second type resource or fourth information on index of preambles dedicated to the device type, wherein a location of the second type resource is different from a location of the first type resource, and
transmit, to the base station, a preamble based on at least one of the ROs dedicated to the device type or the preambles dedicated to the device type.

14. The terminal of claim 11, wherein the first information is transmitted to the base station through message 3 during the random access procedure.

15. The terminal of claim 12, wherein the at least one processor is further configured to receive, from the base station, a random access response (RAR) on a common control channel which is the first type resource, and
wherein, a location of the common control channel is identified by fifth information on a second offset relative to the second type resource in the system information.

16. A base station in a wireless communication system, comprising:
a transceiver; and
at least one processor coupled with the transceiver, and configured to:
perform a random access procedure with a terminal by receiving, from the terminal, first information related to a device type associated with fixed wireless access (FWA) during the random access procedure, and
transmit, to the terminal, signals based on a first type resource which is dedicated to the device type associated with the FWA.

17. The base station of claim 16,
wherein the at least one processor is further configured to:
transmit, to the terminal, system information including second information on a resource location for random access occasions (ROs) dedicated to the device type, and
receive, from the terminal, a preamble on the ROs dedicated to the device type,
wherein the second information includes a first offset of the resource location of the ROs relative to ROs which are not dedicated to the device type, and
wherein the first offset is at least one of a time domain offset or a frequency domain offset.

18. The base station of claim 16,
wherein the at least one processor is further configured to:
transmit, to the terminal, at least one of third information on index of ROs dedicated to the device type on ROs of a second type resource or fourth information on index of preambles dedicated to the device type, wherein a location of the second type resource is different from a location of the first type resource, and
receive, from the terminal, a preamble based on at least one of the ROs dedicated to the device type or the preambles dedicated to the device type.

19. The base station of claim 16, wherein the first information is received from the terminal through message 3 during the random access procedure.

20. The base station of claim 17,
wherein the at least one processor is further configured to transmit, to the terminal, a random access response (RAR) on a common control channel which is the first type resource, and
wherein, a location of the common control channel is identified by fifth information on a second offset relative to the second type resource in the system information.
